(19) United States
(12) Patent Application Publication
(10) Pub. No.: US 2004/0265184 A1
(43) Pub. Date: Dec. 30, 2004

(54) Microchemical chip and method for producing the same

(75) Inventors: Shin Matsuda, Kokubu-shi (JP); Kuninori Yokomine, Kokubu-shi (JP)

Correspondence Address: HOGAN & HARTSON L.L.P., 500 S. GRAND AVENUE, SUITE 1900, LOS ANGELES, CA, 90071-2611, US

(73) Assignee: KYOCERA CORPORATION

(21) Appl. No.: 10/825,086

(22) Filed: Apr. 15, 2004

(30) Foreign Application Priority Data
Apr. 18, 2003 (JP) P2003-114820
Apr. 18, 2003 (JP) P2003-114821
May 12, 2003 (JP) P2003-133581
May 28, 2003 (JP) P2003-151507
May 28, 2003 (JP) P2003-151508

(51) Int. Cl. B01L 3/00

(52) U.S. Cl. 422/100

(57) ABSTRACT

A substrate provided with a channel through which a fluid to be treated flows is formed by forming a groove portion by pressing a surface of a ceramic green sheet with a pattern having a predetermined shape, laminating another ceramic green sheet on the surface of the ceramic green sheet in which the groove portion is formed in such a manner that the groove portion is covered, and sintering the laminated ceramic green sheets at a predetermined temperature, so that a microchemical chip is obtained. The microchemical chip is provided with a structure for generating a turbulent flow in the fluid to be treated flowing through the channel.

### BACKGROUND OF THE INVENTION

1. Field of the Invention

The present invention relates to a microchemical chip in which a predetermined treatment such as a reaction or analysis can be performed with respect to a fluid to be treated such as a substance or a reagent that flows through a small channel, and a method for producing the same. More specifically, the present invention relates to a microchemical chip in which it is possible to mix a plurality of different fluids to be treated and then perform a predetermined treatment, for example, as in the case where blood and a reagent are mixed to cause a reaction, and a method for producing the same.

2. Description of the Related Art

In recent years, in the fields of the chemical technology and the biochemical technology, research to perform reaction with a sample or analysis of a sample in a small area has been conducted, and microchemical systems that are miniaturized systems for chemical reactions, biochemical reactions and analysis of samples have been researched and developed, using a Micro Electro Mechanical Systems (abbreviated as MEMS) technology.

The reaction and the analysis in the microchemical systems are performed with one chip called a microchemical chip in which a microchannel, a micropump, and a microreactor are formed. For example, the following microchemical chip is proposed: a supply port for supplying a fluid such as a sample and a reagent and a collection port for guiding a treated fluid are formed in a substrate made of silicon, glass or resin, the supply port and the collection port are connected via a microchannel whose cross-section area is small, and a micropump for sending a fluid to an appropriate position of the microchannel is provided (see Japanese Unexamined Patent Publication JP-A 2002-214241 (pages 4-5, FIG. 1) and Japanese Unexamined Patent Publication JP-A 2002-233792 (pages 5-6, FIGS. 1 and 3)). Furthermore, a microchemical chip including means for sending a fluid of capillary migration type utilizing an electro-osmosis phenomenon, instead of the micropump is also proposed (see Japanese Unexamined Patent Publication JP-A 2001-108619 (page 5, FIGS. 1 and 2). In these microchemical chips, the microchannels are connected or branched at predetermined positions, and fluids are mixed at the junction portion, or the fluid is separated at the branching portion.

In the microchemical system, compared with the conventional systems, the equipment and the techniques are miniaturized, and therefore the surface area of a reaction per unit volume of a sample can be increased so that the reaction time can be reduced significantly. Moreover, it is possible to control the flow rate precisely, so that reaction and analysis can be performed efficiently. Furthermore, the amount of a sample or a reagent necessary for reaction or analysis can be reduced.

Since the microchemical system has these advantages, the microchemical system is expected to be applied to the medical field. For example, since the amount of blood that is a specimen can be reduced by using a microchemical chip in a blood test, burden on a patient can be reduced. Furthermore, since the amount of a reagent necessary for a test can be reduced, the cost of the test can be reduced.

Furthermore, in the medical field, it has been examined to combine the microchemical chip with the semiconductor technology. For example, as a device used to test the blood of a patient at home or outside medical institutes, and send the test results to a medical institute, a “health care device” in which in addition to a microchannel, a micropump, and a microreactor, a needle for collecting blood, a filter for filtering blood, and a micro-spectroscope, a micro-plasma power and a detecting circuit for analyzing blood are mounted on a substrate made of silicon is conceived (see “NIKKEI MICRODEVICES, July, 2000”, NIKKEI Business Publications Inc., July, 2000, pp. 88-97).

A substrate of the microchemical chip is made of silicon, glass or resin, and therefore when a channel is formed, it is necessary to perform etching processing using the MEMS technique. For example, in the technique disclosed in JP-A 2002-233792 (pages 5 to 6, FIGS. 1 and 3), a microchip having protrusions in the channel is produced by performing etching to a silicon substrate many times. Therefore, the productivity is poor and the production cost is high, so that microchemical chips using a substrate made of silicon, glass or resin are expensive. In addition, in etching processing, the shape of the surface of the side wall of the channel cannot be controlled, and therefore it is difficult to form a channel whose side wall has a desired surface shape.

Furthermore, the conditions under which a microchemical chip using a substrate made of resin is used are limited because of its chemical resistance problem.

Further, in the microchemical chip, a fluid to be treated flows through a channel in the form of a laminar flow. Therefore, when pouring a plurality of different fluids to be treated from a plurality of supply portions to a channel and mixing the fluids, the plurality of fluids to be treated are mixed utilizing a diffusion phenomenon generated while the fluids are flowing through the channel. Therefore, in order to mix the plurality of fluids sufficiently, it is necessary to form a long channel on the further downstream side from the junction position where the supply portions are connected to the channel.

However, when a long channel is formed in order to mix fluids sufficiently, the size of a microchemical chip is increased.

On the other hand, when a short channel is formed in order to decrease the size of the microchemical chip, the fluids cannot sufficiently be mixed. Furthermore, when the fluids cannot sufficiently be mixed, it is highly possible that a predetermined treatment such as reaction is performed insufficiently.

### SUMMARY OF THE INVENTION

An object of the invention is to provide a microchemical chip having high productivity, inexpensive production cost and excellent chemical resistance and which can be used under various conditions and a method for producing the same.

An another object of the invention is to provide a microchemical chip which can efficiently mix the plurality of different fluids to be treated without increasing the size thereof and a method for producing the same.

The invention provide a microchemical chip comprising a substrate provided with a channel through which a fluid to be treated flows, in which a predetermined treatment is performed with respect to the fluid to be treated flowing through the channel,

wherein the substrate is made of a ceramic material.

According to the invention, the fluid to be treated such as a specimen or a substance flows through the channel formed in the substrate made of a ceramic material, and the predetermined treatment such as analysis or a reaction is performed to the fluid to be treated flowing the channel. Since the substrate is made of a ceramic material, the substrate having the channel can be formed only by simple processing without performing complicated processing such as etching processing that is necessary when forming a channel in the substrate made of silicon, glass or resin. Therefore, the microchemical chip of the invention has a high productivity and a low production cost, and therefore is inexpensive. In addition, the ceramic material has more excellent chemical resistance than resin or the like, so that the microchemical chip the invention can be used under various conditions. In other words, when the substrate is made of a ceramic material, a microchemical chip having a high productivity, is inexpensive, has excellent chemical resistance, and can be used under various conditions can be obtained.

In the invention, the substrate comprises a supply portion from which a fluid to be treated is poured into the channel, and a collection portion from which the treated fluid is drawn to the outside, and

the fluid to be treated is poured from the supply portion to the channel, and the predetermined treatment is performed to the poured fluid to be treated, and then the treated fluid is drawn from the collection portion to the outside.

According to the invention, when the fluid to be treated is poured from the supply portion to the channel, the predetermined treatment is performed to the poured fluid to be treated, and then the treated fluid is drawn to the outside from the collection portion. Therefore, the microchemical chip in which the fluid to be treated containing a substance is poured from the supply portion to the channel and the substance is reacted at a predetermined position in the channel, and then a reaction product can be collected from the collection portion can be obtained.

In the invention, the substrate comprises a plurality of supply portions from which a plurality of fluids to be treated are poured into the channel, respectively, and a collection portion from which the treated fluids are drawn to the outside, and

the plurality of fluids to be treated are poured from the plurality of supply portions into the channel, respectively, the plurality of fluids poured are merged and subjected to the predetermined treatment, and then the treated fluids are drawn from the collection portion to the outside.

According to the invention, when the plurality of fluids to be treated are poured from the plurality of supply portions into the channel, respectively, the plurality of fluids poured are merged and subjected to the predetermined treatment, and then the treated fluids are drawn to the outside from the collection portion. Therefore, a microchemical chip can be obtained in which, for example, with two supply portions, when pouring a compound that is a raw material from one supply portion, pouring a reagent from another supply portion, mixing the compound and the reagent sufficiently to cause a reaction, then the obtained compound can be collected from the collection portion.

The invention provides a microchemical chip comprising a substrate provided with a channel through which a fluid to be treated flows and a plurality of supply portions connected to the channel and from which a plurality of fluids to be treated are poured into the channel, respectively, wherein the plurality of fluids to be treated are poured from the plurality of supply portions into the channel, respectively, and the plurality of fluids poured are merged and subjected to a predetermined treatment,

wherein the channel has a turbulent flow generating portion on a downstream side in a flowing direction of the fluid to be treated from a position where the supply portions are connected.

According to the invention, when fluids to be treated are poured from the plurality of supply portions, the poured fluids are merged and flows through the channel, and are subjected to the predetermined treatment. Therefore, when the plurality of different fluids to be treated are poured from the plurality of supply portions, respectively, the plurality of fluids that are poured and merged flow through the channel and are subjected to the predetermined treatment. The plurality of supply portions and the channel can be connected in one position in the channel, such as in the uppermost stream, or can be connected with a displacement.

In the invention, the channel has the turbulent flow generating portion on the downstream side from the position where the supply portions are connected. Therefore, when a plurality of fluids to be treated are merged into one and pass through the turbulent flow generating portion, then a turbulent flow is generated in the merged fluids. Thus, the plurality of fluids to be treated can be mixed by generating a turbulent flow in the merged fluids to be treated.

Thus, compared with the case of mixing the fluids only by diffusion as conventionally performed, even with a short channel, the plurality of fluids can be mixed sufficiently. Furthermore, since the predetermined treatment is performed in the state where the plurality of fluids are mixed sufficiently, the predetermined treatment can be performed reliably, compared with the case where the mixture is insufficient. Furthermore, since the length of the channel on the downstream side in the flowing direction of the fluid from the position where the supply portions are connected can be reduced, the size of the microchemical chip can be reduced.

In the invention, the turbulent flow generating portion is a hydrophilic portion having a hydrophilic wall surface.

According to the invention, the channel has the hydrophilic portion having the hydrophilic wall surface that is the turbulent flow generating portion on the downstream side from the position in which the supply portions are connected. Therefore, when a plurality of hydrophobic fluids to be treated pass through the hydrophilic portion after being merged into one, a turbulent flow is generated in the merged fluids. This is because the fluids pass through channel portions whose wall surfaces have different properties. In other words, when merging hydrophobic fluids to be treated, the wall surface of a predetermined channel portion in the downstream is formed so as to be more hydrophilic than the wall surface of the channel portion on the upstream side from that portion. Thus, when the merged fluid is poured from the portion having a wall surface of low hydrophilicity to the portion having a wall surface of high hydrophilicity, a turbulent flow is generated in the fluid. Thus, a plurality of fluids to be treated can be mixed by generating a turbulent flow in the merged fluids to be treated. Consequently, compared with the case where fluids are mixed only by diffusion as conventionally performed, even with a short channel, a plurality of hydrophobic fluids to be treated can be mixed sufficiently. Furthermore, since a predetermined treatment is performed in the state where the plurality of fluids are mixed sufficiently, the predetermined treatment can be performed reliably, compared with the case where the mixture is insufficient. Furthermore, compared with the case mixing the fluids only by diffusion, the channel can be short. Thus, the size of the microchemical chip can be reduced.

In the invention, the turbulent flow generating portion is a hydrophobic portion having a hydrophobic wall surface.

According to the invention, the channel has the hydrophobic portion having the hydrophobic wall surface that is the turbulent flow generating portion on the downstream side from the position in which the supply portions are connected. Therefore, when a plurality of hydrophilic fluids to be treated pass through the hydrophobic portion after being merged into one, a turbulent flow is generated in the merged fluids. This is because the fluids pass through channel portions whose wall surfaces have different properties. In other words, when merging hydrophilic fluids to be treated, the wall surface of a predetermined channel portion in the downstream is formed so as to be more hydrophobic than the wall surface of the channel portion on the upstream side from that portion. Thus, when the merged fluid is poured from the portion having a wall surface of low hydrophobicity to the portion having a wall surface of high hydrophobicity, a turbulent flow is generated in the fluid.

Thus, a plurality of fluids to be treated can be mixed by generating a turbulent flow in the merged fluids to be treated. Consequently, compared with the case where fluids are mixed only by diffusion as conventionally performed, even with a short channel, a plurality of hydrophilic fluids to be treated can be mixed sufficiently. Furthermore, since the predetermined treatment is performed in the state where the plurality of fluids are mixed sufficiently, the predetermined treatment can be performed reliably, compared with the case where the mixture is insufficient. Furthermore, compared with the case mixing the fluids only by diffusion, the channel can be short. Thus, the size of the microchemical chip can be reduced.

In the invention, the turbulent flow generating portion is a bend portion.

According to the invention, a plurality of fluids to be treated such as a substance and a reagent are poured from the plurality of supply portions into the channel, respectively, merged and flow through the bend portion of the channel that is the turbulent flow generating portion, and then subjected to the predetermined treatment such as analysis and reaction. When the plurality of fluids to be treated that are merged flow through the bend portion of the channel, a turbulent flow can be generated in the plurality of fluids that are merged. By generating a turbulent flow in the plurality of fluids that are merged in this manner, the plurality of fluids to be treated can be mixed. Thus, compared with the case of mixing the fluids only by diffusion as conventionally performed, even with a short channel, the plurality of fluids can be mixed sufficiently. Furthermore, since the predetermined treatment is performed in the state where the plurality of fluids are mixed sufficiently, the predetermined treatment can be performed reliably, compared with the case where the mixture is insufficient. Furthermore, compared with the case mixing the fluids only by diffusion, the channel can be short. Thus, the size of the microchemical chip can be reduced.

In the invention, the bend portion of the channel is formed by coupling a plurality of channels having a different distance from the substrate surface with a channel extending in a direction perpendicular to the substrate surface.

According to the invention, the bend portion of the channel is not formed in a plane parallel to the substrate surface, but is formed inside the substrate three-dimensionally by coupling a plurality of channels having a different distance from the substrate surface with a channel extending in a direction perpendicular to the substrate surface. Thus, compared with the case where the bend portion of the channel is formed in a plane parallel to the substrate surface, the area of the projected image of the bend portion of the channel on the substrate surface can be reduced. Therefore, the size of the microchemical chip can be reduced.

In the invention, the turbulent flow generating portion is an uneven portion having an uneven wall surface.

In the invention, the channel has the uneven portion having the uneven wall surface that is the turbulent flow generating portion on the downstream side from the position in which the supply portions are connected. Therefore, when the plurality of fluids to be treated are merged into one and pass through the uneven portion, then a turbulent flow is generated in the merged fluids. Thus, a plurality of fluids to be treated can be mixed by generating a turbulent flow in the merged fluids to be treated.

Thus, compared with the case of mixing the fluids only by diffusion as conventionally performed, even with a short channel, the plurality of fluids can be mixed sufficiently. Furthermore, since a predetermined treatment is performed in the state where the plurality of fluids are mixed sufficiently, the predetermined treatment can be performed reliably, compared with the case where the mixture is insufficient. Furthermore, since the length of the channel on the downstream side in the flowing direction of the fluid from the position in which the supply portions are connected can be reduced, the size of the microchemical chip can be reduced.

In the invention, the substrate further comprises a collection portion connected to the channel and from which a treated fluid is drawn to the outside, and

wherein the turbulent flow generating portion is provided on the downstream side in the flowing direction of the fluid to be treated from the position in which the supply portions are connected and on an upstream side in the flowing direction of the fluid to be treated from a position in which the collection portion is connected, and

the plurality of fluids to be treated are poured from the plurality of supply portions into the channel, respectively, and the plurality of fluids poured are merged and subjected to the predetermined treatment, and then the treated fluid is drawn from the collection portion to the outside.

According to the invention, the plurality of fluids to be treated poured to the channel from the plurality of supply portions, respectively, are merged and mixed rapidly by flowing through the turbulent flow generating portion, and subjected to the predetermined treatment, and then drawn from the collection portion to the outside. Therefore, a small microchemical chip can be obtained in which, for example, with two supply portions, when pouring a compound that is a raw material from one supply portion, pouring a reagent from another supply portion, mixing the compound and the reagent sufficiently to cause a reaction, then the obtained compound can be collected from the collection portion.

In the invention, the turbulent flow generating portion is a hydrophilic portion having a hydrophilic wall surface.

According to the invention, a plurality of hydrophobic fluids to be treated poured to the channel from the plurality of supply portions, respectively, are merged and mixed rapidly by flowing through the hydrophilic portion, and subjected to the predetermined treatment, and then drawn from the collection portion to the outside. Therefore, a small microchemical chip can be obtained in which, for example, with two supply portions, when pouring a hydrophobic compound that is a raw material from one supply portion, pouring a reagent from another supply portion, mixing the compound and the reagent sufficiently to cause a reaction, then the obtained compound can be collected from the collection portion.

In the invention, the turbulent flow generating portion is a hydrophobic portion having a hydrophobic wall surface.

According to the invention, a plurality of hydrophilic fluids to be treated poured to the channel from the plurality of supply portions, respectively, are merged and mixed rapidly by flowing through the hydrophobic portion, and subjected to the predetermined treatment, and then drawn from the collection portion to the outside. Therefore, a small microchemical chip can be obtained in which, for example, with two supply portions, when pouring a hydrophilic compound that is a raw material from one supply portion, pouring a reagent from another supply portion, mixing the compound and the reagent sufficiently to cause a reaction, then the obtained compound can be collected from the collection portion.

In the invention, the turbulent flow generating portion is a bend portion.

In the invention, the bend portion of the channel is formed by coupling a plurality of channels having a different distance from the substrate surface with a channel extending in a direction perpendicular to the substrate surface.

According to the invention, the plurality of fluids to be treated poured to the channel from the plurality of supply portions, respectively, are merged and mixed rapidly by flowing through the bend portion, and subjected to a predetermined treatment, and then drawn from the collection portion to the outside. Therefore, a small microchemical chip can be obtained in which, for example, with two supply portions, when pouring a compound that is a raw material from one supply portion, pouring a reagent from another supply portion, mixing the compound and the reagent sufficiently to cause a reaction, then the obtained compound can be collected from the collection portion.

In the invention, the turbulent flow generating portion is an uneven portion having an uneven wall surface.

According to the invention, a plurality of fluids to be treated poured to the channel from the plurality of supply portions, respectively, are merged and mixed rapidly by flowing through the uneven portion, and subjected to a predetermined treatment, and then drawn from the collection portion to the outside. Therefore, a small microchemical chip can be obtained in which, for example, with two supply portions, when pouring a compound that is a raw material from one supply portion, pouring a reagent from another supply portion, mixing the compound and the reagent sufficiently to cause a reaction, then the obtained compound can be collected from the collection portion.

In the invention, the substrate comprises a treatment portion in which the predetermined treatment is performed to the merged fluids on the downstream side in a flowing direction of the fluid to be treated from the position in which the supply portions are connected to the channel, and

wherein the turbulent flow generating portion is provided on the downstream side in the flowing direction of the fluid to be treated from the position in which the supply portions are connected and on an upstream side in the flowing direction of the fluid to be treated from the treatment portion.

According to the invention, a plurality of fluids to be treated poured to the channel from the plurality of supply portions, respectively, are merged and mixed rapidly by flowing through the turbulent flow generating portion, and subjected to the predetermined treatment in the treatment portion. Therefore, for example, when two supply portions are provided, a compound that is a raw material from one supply portion is poured, a reagent is poured from another supply portion, and the compound and the reagent are merged and heated in the treatment portion to cause a reaction, then the compound and the reagent can be heated with being mixed sufficiently. Consequently, the compound and the reagent can be reacted efficiently and the yield of a reaction product can be improved.

In the invention, the turbulent flow generating portion is a hydrophilic portion having a hydrophilic wall surface.

According to the invention, a plurality of hydrophobic fluids to be treated poured to the channel from the plurality of supply portions, respectively, are merged and mixed rapidly by flowing through the hydrophilic portion, and subjected to a predetermined treatment in the treatment portion. Therefore, for example, when two supply portions are provided, a hydrophobic compound that is a raw material from one supply portion is poured, a reagent is poured from another supply portion, and the compound and the reagent are merged and heated in the treatment portion to cause a reaction, then the compound and the reagent can be heated with being mixed sufficiently. Consequently, the compound and the reagent can be reacted efficiently and the yield of a reaction product can be improved.

In the invention, the turbulent flow generating portion is a hydrophobic portion having a hydrophobic wall surface.

According to the invention, a plurality of hydrophilic fluids to be treated poured to the channel from the plurality of supply portions, respectively, are merged and mixed rapidly by flowing through the hydrophobic portion, and subjected to a predetermined treatment in the treatment portion. Therefore, for example, when two supply portions are provided, a hydrophilic compound that is a raw material from one supply portion is poured, a reagent is poured from another supply portion, and the compound and the reagent are merged and heated in the treatment portion to cause a reaction, then the compound and the reagent can be heated with being mixed sufficiently. Consequently, the compound and the reagent can be reacted efficiently and the yield of a reaction product can be improved.

In the invention, the turbulent flow generating portion is a bend portion.

In the invention, the bend portion of the channel is formed by coupling a plurality of channels having a different distance from the substrate surface with a channel extending in a direction perpendicular to the substrate surface.

According to the invention, a plurality of fluids to be treated poured to the channel from the plurality of supply portions, respectively, are merged and mixed rapidly by flowing through the bend portion, and subjected to a predetermined treatment in the treatment portion. Therefore, for example, when two supply portions are provided, a compound that is a raw material from one supply portion is poured, a reagent is poured from another supply portion, and the compound and the reagent are merged and heated in the treatment portion to cause a reaction, then the compound and the reagent can be heated with being mixed sufficiently. Consequently, the compound and the reagent can be reacted efficiently and the yield of a reaction product can be improved.

In the invention, the turbulent flow generating portion is an uneven portion having an uneven wall surface.

According to the invention, the plurality of fluids to be treated poured to the channel from the plurality of supply portions, respectively, are merged and mixed rapidly by flowing through the uneven portion, and subjected to a predetermined treatment in the treatment portion. Therefore, for example, when two supply portions are provided, a compound that is a raw material from one supply portion is poured, a reagent is poured from another supply portion, and the compound and the reagent are merged and heated in the treatment portion to cause a reaction, then the compound and the reagent can be heated with being mixed sufficiently. Consequently, the compound and the reagent can be reacted efficiently and the yield of a reaction product can be improved.

The invention provides a microchemical chip comprising a substrate provided with a channel through which a fluid to be treated flows, and in which a predetermined treatment is performed with respect to the fluid to be treated flowing through the channel,

wherein the channel is formed by covering one surface of a substrate main body, on one surface of which a groove portion is formed, with a covering portion, and at least the substrate main body is made of a ceramic material.

According to the invention, the substrate comprises the substrate main body and the covering portion, the fluid to be treated such as a specimen or a substance flows through a channel formed by covering one surface of the substrate main body, on one surface of which a groove portion is formed, with the covering portion, and the predetermined treatment such as analysis or reaction is performed to the fluid to be treated flowing through the channel. The substrate main body is made of a ceramic material, so that the substrate main body having a channel can be produced only by simple processing without performing complicated processing such as etching processing that is necessary when forming a channel in a substrate made of silicon, glass or resin. Therefore, the microchemical chip of the invention has a high productivity and a low production cost, and therefore is inexpensive. In addition, the ceramic material has more excellent chemical resistance that resin or the like, so that the microchemical chip of the invention can be used under various conditions. In other words, the substrate main body is made of a ceramic material, so that a microchemical chip that has a high productivity, is inexpensive, has excellent chemical resistance, and can be used under various conditions can be obtained.

In the invention, the substrate comprises a supply portion from which a fluid to be treated is poured into the channel, and a collection portion from which the treated fluid is drawn to the outside, and

the fluid to be treated is poured from the supply portion to the channel, the predetermined treatment is performed to the poured fluid to be treated, and then the treated fluid is drawn from the collection portion to the outside.

According to the invention, when the fluid to be treated is poured from the supply portion to the channel, a predetermined treatment is performed to the poured fluid to be treated, and then the treated fluid is drawn to the outside from the collection portion. Therefore, a microchemical chip in which the fluid to be treated containing a substance is poured from the supply portion to the channel, the substance is reacted at a predetermined position in the channel, and then a reaction product can be collected from the collection portion can be obtained.

In the invention, the substrate comprises a plurality of supply portions from which a plurality of fluids to be treated are poured into the channel, respectively, and a collection portion from which the treated fluids are drawn to the outside, and

the plurality of fluids to be treated are poured from the plurality of supply portions into the channel, respectively, and the plurality of fluids poured are merged and subjected to a predetermined treatment, and then the treated fluids are drawn from the collection portion to the outside.

According to the invention, when the plurality of fluids to be treated are poured from the plurality of supply portions into the channel, respectively, the plurality of fluids poured are merged and subjected to a treatment, and then the treated fluids are drawn to the outside from the collection portion. Therefore, a microchemical chip can be obtained in which, for example, with two supply portions, when pouring a compound that is a raw material from one supply portion, pouring a reagent from another supply portion, mixing the compound and the reagent sufficiently to cause a reaction, then the obtained compound can be collected from the collection portion.

The invention provides a microchemical chip comprising a substrate provided with a channel through which a fluid to be treated flows and a plurality of supply portions connected to the channel and from which a plurality of fluids to be treated are poured into the channel, respectively, wherein the plurality of fluids to be treated are poured from the plurality of supply portions into the channel, respectively, and the plurality of fluids poured are merged and subjected to a predetermined treatment,

wherein a vibrating element is provided in a vicinity of a position in which the channel is connected to the supply portion.

According to the invention, when fluids to be treated are poured from the plurality of supply portions, the poured fluids are merged and flows through the channel, and are subjected to a predetermined treatment. Therefore, when a plurality of different fluids to be treated are poured from the plurality of supply portions, respectively, the plurality of fluids that are poured and merged flow through the channel and are subjected to the predetermined treatment. The plurality of supply portions and the channel can be connected in one position in the channel, such as in the uppermost stream, or can be connected with a displacement.

In the invention, a vibrating element is provided in the vicinity of the position in which the channel is connected to the supply portions, so that vibration from the vibrating element is transmitted to the merged fluids, and thus a turbulent flow is generated in the merged fluids. By generating a turbulent flow in the merged fluids, a plurality of fluids can be mixed.

Thus, compared with the case of mixing the fluids only by diffusion as conventionally performed, even with a short channel, the plurality of fluids can be mixed sufficiently. Furthermore, since a predetermined treatment is performed in the state where the plurality of fluids are mixed sufficiently, the predetermined treatment can be performed reliably, compared with the case where the mixture is insufficient. Furthermore, since the length of the channel on a downstream side in the flowing direction of the fluid from the position in which the supply portions are connected can be reduced, the size of the microchemical chip can be reduced.

In the invention, the substrate comprises a substrate main body in which a groove portion is formed and a covering member provided such that the groove portion is covered, and the channel is formed by covering the groove portion formed in the substrate main body with the covering member, and

the vibrating element is provided in the covering member at a position corresponding to an inner surface of a channel portion in a vicinity of a position in which the supply portions are connected on a downstream side in a flowing direction of a fluid to be treated from that position.

According to the invention, the vibrating element is provided in the covering member at the position corresponding to an inner surface in a channel portion in the vicinity of the position in which the supply portions are connected to the channel on the downstream side in the flowing direction of a fluid to be treated from that position, that is, in a channel portion through which a plurality of fluids that are merged flow. Therefore, the vibration from the vibrating element is transmitted efficiently to the merged fluids. Thus; the merged fluids can be mixed sufficiently.

In the invention, the substrate further comprises a collection portion connected to the channel and from which a treated fluid is drawn to the outside, and

wherein the vibrating element is provided on the downstream side in a flowing direction of the fluid to be treated from a position in which the supply portions are connected and on an upstream side in the flowing direction of the fluid to be treated from a position in which the collection portion is connected, and

the plurality of fluids to be treated are poured from the plurality of supply portions into the channel, respectively, and the plurality of fluids poured are merged and subjected to the predetermined treatment, and then the treated fluid is drawn from the collection portion to the outside.

According to the invention, the plurality of fluids to be treated poured to the channel from the plurality of supply portions, respectively, are merged and mixed rapidly by the vibration from the vibrating element, and subjected to the predetermined treatment, and then drawn from the collection portion to the outside. Therefore, a small microchemical chip can be obtained in which, for example, with two supply portions, when pouring a compound that is a raw material from one supply portion, pouring a reagent from another supply portion, mixing the compound and the reagent sufficiently to cause a reaction, then the obtained compound can be collected from the collection portion.

In the invention, the substrate comprises a treatment portion in which the predetermined treatment is performed to the merged fluids on the downstream side in the flowing direction of the fluid to be treated from a position in which the supply portions are connected to the channel, and

wherein the vibrating element is provided on the downstream side in the flowing direction of the fluid to be treated from the position in which the supply portions are connected and on an upstream side in the flowing direction of the fluid to be treated from the treatment portion.

According to the invention, the plurality of fluids to be treated poured to the channel from the plurality of supply portions, respectively, are merged and mixed rapidly by the vibration of the vibrating element, and subjected to the predetermined treatment in the treatment portion. Therefore, for example, when two supply portions are provided, a compound that is a raw material from one supply portion is poured, a reagent is poured from another supply portion, and the compound and the reagent are merged and heated in the treatment portion to cause a reaction, then the compound and the reagent can be heated with being mixed sufficiently. Consequently, the compound and the reagent can be reacted efficiently and the yield of a reaction product can be improved.

The invention provides a method for producing a microchemical chip including a substrate provided with a channel through which a fluid to be treated flows, and in which a predetermined treatment is performed to the fluid to be treated flowing through the channel, comprising:

forming a groove portion by pressing a surface of a ceramic green sheet with a pattern having a predetermined shape;

laminating another ceramic green sheet on the surface of the ceramic green sheet in which the groove portion is formed in such a manner that the groove portion is covered; and

sintering the laminated ceramic green sheets at a predetermined temperature to form the substrate.

According to the invention, after the groove portion is formed in the ceramic green sheet by pressing the surface of the ceramic green sheet with the pattern, the other ceramic green sheet is laminated on the surface of the ceramic green sheet in which the groove portion is formed in such a manner that the groove portion is covered, and then the laminated ceramic green sheets are sintered at the predetermined temperature to form the substrate. Therefore, the microchemical chip can be produced only by simple processing without performing complicated processing such as etching processing that is necessary when forming a channel in a substrate made of silicon, glass or resin. Furthermore, in the method for producing a microchemical chip of the invention, the shape of the pressed pattern is transferred into the groove portion that is to serve as a channel, so that a channel having a desired surface shape on the bottom face and the side wall can be formed easily by adjusting the surface shape of the pattern.

In the invention, when forming the substrate by sintering a laminate including at least three ceramic green sheets to cure the laminate, the method comprises:

forming groove portions by pressing a surface of each of at least two ceramic green sheets with a pattern having a predetermined shape and forming as appropriate a through-hole for communicating the groove portions formed in the different ceramic green sheets;

laminating another ceramic green sheet on a surface of the ceramic green sheets in which the groove portions are formed in such a manner that the groove portions are covered; and

sintering the laminated ceramic green sheets at a predetermined temperature so as to form the substrate.

According to the invention, when forming the substrate by sintering a laminate including at least three ceramic green sheets, the substrate having a three-dimensional channel is formed by forming the groove portions by pressing the surface of each of at least two ceramic green sheets with the pattern and forming as appropriate the through-hole for communicating the groove portions formed in the different ceramic green sheets, laminating the other ceramic green sheet on the surface of the ceramic green sheets in which the groove portions are formed in such a manner that the groove portions are covered, and sintering the laminated ceramic green sheets at the predetermined temperature.

For example, when the substrate of the microchemical chip is formed by sintering a laminate including three ceramic green sheets, the substrate is formed in the following manner. First, the groove portions are formed by pressing the surface of each of two ceramic green sheets with a pattern having the predetermined shape and the through-hole for communicating the groove portions formed in the two ceramic green sheets is formed in one of the two ceramic green sheets in which the groove portion is formed. Then, the ceramic green sheet in which the groove portion and the through-hole are formed is laminated on the surface of the ceramic green sheet in which only the groove portion is formed in such a manner that the groove portion of this ceramic green sheet is covered. Furthermore, the other ceramic green sheet is laminated on the surface of this ceramic green sheet in which the groove portion and the through-hole are formed in such a manner that the groove portion of this ceramic green sheet is covered, and the laminated ceramic green sheets are sintered at the predetermined temperature. Thus, the substrate is formed. By forming the substrate in this manner, a microchemical chip in which a channel is formed three-dimensionally can be produced.

The invention provides a method for producing a microchemical chip including a substrate provided with a channel through which a fluid to be treated flows, and in which a predetermined treatment is performed to the fluid to be treated flowing through the channel, comprising:

forming a groove portion by pressing a surface of a ceramic green sheet with a pattern having a predetermined shape;

sintering the ceramic green sheet in which the groove portion is formed at a predetermined temperature to form a substrate main body, and

covering the groove portion on the substrate main body with a covering portion to form the substrate.

According to the invention, the groove portion is formed by pressing the surface of the ceramic green sheet with a pattern, and the ceramic green sheet in which the groove portion is formed is sintered at the predetermined temperature to form a substrate main body, and the groove portion on the substrate main body is covered with a covering portion, so that a substrate having a channel is formed. Therefore, the microchemical chip can be produced only by simple processing without performing complicated processing such as etching processing that is necessary when forming a channel in a substrate made of silicon, glass or resin. Furthermore, in the method for producing a microchemical chip of the invention, the shape of the pressed pattern is transferred into the groove portion that is to serve as a channel, so that a channel having a desired surface shape on the bottom face and the side wall can be formed easily by adjusting the surface shape of the pattern.

In the invention, when forming the substrate main body by sintering a laminate including a plurality of ceramic green sheets, the method comprises:

forming groove portions by pressing a surface of each of at least two ceramic green sheets with a pattern having a predetermined shape and forming as appropriate a through-hole for communicating the groove portions formed in the different ceramic green sheets;

laminating another ceramic green sheet on the surface of the ceramic green sheets in which the groove portions are formed in such a manner that the groove portions are covered; and

sintering the laminated ceramic green sheets at a predetermined temperature to form the substrate main body.

According to the invention, when forming the substrate main body by sintering and curing a laminate including a plurality of ceramic green sheets, the substrate main body is formed by forming the groove portions by pressing the surface of each of at least two ceramic green sheets with the pattern and forming as appropriate the through-hole for communicating the groove portions formed in the different ceramic green sheets, laminating the other ceramic green sheet on the surface of the ceramic green sheets in which the groove portions are formed in such a manner that the groove portions are covered, and sintering the laminated ceramic green sheets at the predetermined temperature. Thus, by covering the groove portion exposed on the substrate main body with the covering portion, a substrate having a three-dimensional channel can be formed.

For example, when the substrate main body is formed by sintering a laminate including two ceramic green sheets, the substrate is formed in the following manner. First, the groove portions are formed by pressing the surface of each of two ceramic green sheets with the pattern and the through-hole for communicating the groove portions formed in the two ceramic green sheets is formed in one of the two ceramic green sheets in which the groove portion is formed. Then, the ceramic green sheet in which the groove portion and the through-hole are formed is laminated on the surface of the ceramic green sheet in which only the groove portion is formed in such a manner that the groove portion of this ceramic green sheet is covered, and the laminated ceramic green sheets are sintered at the predetermined temperature. Thus, the substrate main body is formed. By covering the groove portion exposed on the thus formed substrate main body with the covering portion, a microchemical chip in which a channel is formed three-dimensionally can be produced.

The invention provides a method for producing a microchemical chip including a substrate in which a channel through which a fluid to be treated flows and a plurality of supply portions connected to the channel and from which a plurality of fluids to be treated are poured into the channel, respectively, are formed, and the channel has a hydrophilic portion having a hydrophilic wall surface on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:

forming a groove portion by pressing a surface of a ceramic green sheet with a pattern having a predetermined shape;

sintering the ceramic green sheet in which the groove portion is formed at a predetermined temperature so as to form a substrate main body;

in the case where the substrate main body is hydrophilic,

covering a wall surface desired to be hydrophilic of the wall-surface of the groove portion with a protective film, performing a treatment for providing hydrophobicity to the wall surface excluding the desired wall surface, and removing the protective film, so as to provide hydrophilicity to the desired wall surface, and

in the case where the substrate main body is hydrophobic,

covering portions excluding a wall surface desired to be hydrophilic of the wall surface of the groove portion with a protective film, performing a treatment for providing hydrophilicity to the desired wall surface, and removing the protective film, so as to provide hydrophilicity to the desired wall surface; and

covering the groove portion on a surface of the substrate main body with a covering member so as to form the substrate.

According to the invention, first, the substrate main body is formed by forming the groove portion by pressing the surface of the ceramic green sheet with a pattern, and sintering the ceramic green sheet in which the groove portion is formed at the predetermined temperature.

Then, the treatment for providing hydrophilicity to the wall surface desired to be hydrophilic of the wall surface of the groove portion is performed. In the case where the substrate main body is hydrophilic, the wall surface desired to be hydrophilic of the wall surface of the groove portion with a protective film is covered, and then the treatment for providing hydrophobicity is performed to the wall surface excluding the desired wall surface. Thereafter, the protective film is removed. Thus, the desired wall surface becomes hydrophilic. In the case where the substrate main body is hydrophobic, portions excluding the wall surface desired to be hydrophilic of the wall surface of the groove portion are covered with a protective film, and then a treatment for providing hydrophilicity is performed to the desired wall surface. Thereafter, the protective film is removed. Thus, the desired wall surface becomes hydrophilic.

Thereafter, the groove portion exposed on the surface of the substrate main body is covered with the covering member, so that the substrate is formed. Thus, the channel having the hydrophilic portion having the hydrophilic wall surface is formed in the internal portion of the substrate.

Thus, a microchemical chip having the channel provided with the hydrophilic portion having the hydrophilic wall surface on the downstream side in the flowing direction of the fluid to be treated from the position in which the supply portions are connected to the channel can be produced by forming the substrate in this manner.

The invention provides a method for producing a microchemical chip including a substrate in which a channel through which a fluid to be treated flows and a plurality of supply portions connected to the channel and from which a plurality of fluids to be treated are poured into the channel, respectively, are formed, and the channel has a hydrophobic portion having a hydrophobic wall surface on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:

forming a groove portion by pressing a surface of a ceramic green sheet with a pattern having a predetermined shape;

sintering the ceramic green sheet in which the groove portion is formed at a predetermined temperature so as to form a substrate main body;

in the case where the substrate main body is hydrophilic,

covering portions excluding a wall surface desired to be hydrophobic of the wall surface of the groove portion with a protective film, performing a treatment for providing hydrophobicity to the desired wall surface, and removing the protective film, so as to provide hydrophobicity to the desired wall surface, and

in the case where the substrate main body is hydrophobic,

covering a wall surface desired to be hydrophobic of the wall surface of the groove portion with a protective film, performing a treatment for providing hydrophilicity to portions excluding the desired wall surface, and removing the protective film, so as to provide hydrophobicity to the desired wall surface; and

covering the groove portion on a surface of the substrate main body with a covering member so as to form the substrate.

According to the invention, first, the substrate main body is formed by forming the groove portion by pressing the surface of a ceramic green sheet with the pattern, and sintering the ceramic green sheet in which the groove portion is formed at the predetermined temperature.

Then, the treatment for providing hydrophobicity to the wall surface desired to be hydrophobic of the wall surface of the groove portion is performed. In the case where the substrate main body is hydrophilic, portions excluding the wall surface desired to be hydrophobic of the wall surface of the groove portion are covered with the protective film, and then the treatment for providing hydrophobicity is performed to the desired wall surface. Thereafter, the protective film is removed. Thus, the desired wall surface is allowed to be hydrophobic. In the case where the substrate main body is hydrophobic, the wall surface desired to be hydrophobic of the wall surface of the groove portion is covered with the protective film, and then the treatment for providing hydrophilicity is performed to portions excluding the desired wall surface. Thereafter, the protective film is removed. Thus, the desired wall surface is allowed to be hydrophobic.

Thereafter, the groove portion exposed on the surface of the substrate main body is covered with the covering member, so that the substrate is formed. Thus, a the having the hydrophobic portion having the hydrophobic wall surface is formed in the internal portion of the substrate.

Thus, a microchemical chip having the channel provided with the hydrophobic portion having the hydrophobic wall surface on the downstream side in the flowing direction of the fluid to be treated from the position in which the supply portions are connected can be produced by forming the substrate in this manner.

The invention provides a method for producing a microchemical chip including a substrate in which a channel through which a fluid to be treated flows and a plurality of supply portions connected to the channel and from which a plurality of fluids to be treated are poured into the channel, respectively, are formed, and the channel has a bend portion on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:

forming groove portions by pressing a surface of each of at least two ceramic green sheets with a pattern having a predetermined shape and forming as appropriate a through-hole for communicating the groove portions formed in the different ceramic green sheets;

laminating another ceramic green sheet on the surface of the ceramic green sheets in which the groove portions are formed in such a manner that the groove portions are covered, and that the groove portions formed in the different ceramic green sheets are communicated through the through-hole; and

sintering the laminated ceramic green sheets at a predetermined temperature so as to form the substrate.

According to the invention, first, the groove portions are formed by pressing the surface of each of at least two ceramic green sheets with the pattern having the predetermined shape, and the through-hole for communicating the groove portions formed in the different ceramic green sheets is formed as appropriate. For example, when the substrate is to be formed by using three ceramic green sheets, the groove portions are formed by pressing on the surface of each of two ceramic green sheets with the pattern having the predetermined shape, and the through-hole for communicating the groove portions formed in the two ceramic green sheets is formed in one of the two ceramic green sheets in which the groove portions are formed.

Then, the other ceramic green sheet is laminated on the surface of the ceramic green sheet in which the groove portion is formed such that the groove portions are covered, and that the groove portions formed in the different ceramic green sheets are communicated through the through-hole. For example, when the substrate is to be formed by using three ceramic green sheets, the second ceramic green sheet in which the groove portion and the through-hole are formed is laminated on the surface of the first ceramic green sheet in which only the groove portion is formed in such a manner that the groove portion of this ceramic green sheet is covered. Furthermore, the third ceramic green sheet is laminated on the surface of the second ceramic green sheet in which the groove portion and the through-hole are formed in such a manner that the groove portion of this ceramic green sheet is covered. In this case, the two ceramic green sheets in which the groove portions are formed are laminated such that the groove portions are communicated through the through-hole.

Then, the laminated ceramic green sheets are sintered at the predetermined temperature, so that the substrate is formed. Thus, a three-dimensional channel in which a plurality of channels having a different distance from the substrate surface are coupled with the through-hole extending in a direction perpendicular to the substrate surface can be formed in the internal portion of the substrate.

Thus, a microchemical chip having the channel provided with the bend portion on the downstream side in the flowing direction of the fluid to be treated from the position in which the supply portions are connected can be produced by forming the substrate in this manner.

The invention provides a method for producing a microchemical chip including a substrate in which a channel through which a fluid to be treated flows and a plurality of supply portions connected to the channel and from which a plurality of fluids to be treated are poured into the channel, respectively, are formed, and the channel has a bend portion on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:

forming groove portions by pressing a surface of each of at least two ceramic green sheets with a pattern having a predetermined shape and forming as appropriate a through-hole for communicating the groove portions formed in the different ceramic green sheets;

laminating another ceramic green sheet on the surface of the ceramic green sheets in which the groove portions are formed in such a manner that the groove portions are covered, and that the groove portions formed in the different ceramic green sheets are communicated through the through-hole;

sintering the laminated ceramic green sheets at a predetermined temperature to form a substrate main body; and

covering the groove portion on the substrate main body with a covering portion so as to form the substrate.

According to the invention, first, the groove portions are formed by pressing the surface of each of at least two ceramic green sheets with the pattern, and the through-hole for communicating the groove portions formed in the different ceramic green sheets is formed as appropriate. For example, when the substrate main body is to be formed by using two ceramic green sheets, the groove portions are formed by pressing the surface of each of the two ceramic green sheets with the pattern having the predetermined shape, and the through-hole for communicating the groove portions formed in the two ceramic green sheets is formed in one of the two ceramic green sheets in which the groove portions are formed.

Then, the other ceramic green sheet is laminated on the surface of the ceramic green sheets in which the groove portions are formed such that the groove portions are covered, and that the groove portions formed in the different ceramic green sheets are communicated through the through-hole. For example, when the substrate main body is to be formed by using two ceramic green sheets, the second ceramic green sheet in which the groove portion and the through-hole are formed is laminated on the surface of the first ceramic green sheet in which only the groove portion is formed in such a manner that the groove portion of this ceramic green sheet is covered, and that the groove portions of the two ceramic green sheets are communicated through the through-hole.

Then, the laminated ceramic green sheets are sintered at the predetermined temperature, so that the substrate main body is formed. Then, the groove portion exposed on the surface of the substrate main body is covered with a covering portion, so that the substrate is formed. Thus, a three-dimensional channel in which a plurality of channels having a different distance from the substrate surface are coupled with the through-hole extending in a direction perpendicular to the substrate surface can be formed in the internal portion of the substrate.

Thus, a microchemical chip having the channel provided with the bend portion on the downstream side in the flowing direction of the fluid to be treated from the position in which the supply portions are connected can be produced by forming the substrate in this manner.

The invention provides a method for producing a microchemical chip including a substrate in which a channel through which a fluid to be treated flows and a plurality of supply portions connected to the channel and from which a plurality of fluids to be treated are poured into the channel, respectively, are formed, and the channel has an uneven portion having an uneven wall surface on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:

forming a groove portion and forming unevenness in a predetermined wall surface of the groove portion by pressing a surface of a ceramic green sheet with a pattern having a predetermined shape;

laminating another ceramic green sheet on a surface of the ceramic green sheet in which the groove portion is formed in such a manner that the groove portion is covered; and

sintering the laminated ceramic green sheets at a predetermined temperature so as to form the substrate.

According to the invention, first, a groove portion is formed and unevenness is formed on a predetermined wall surface of the groove portion by pressing the surface of the ceramic green sheet with the pattern. Then, the other ceramic green sheet is laminated on the surface of the ceramic green sheet in which the groove portion is formed in such a manner that the groove portion is covered, and the laminated ceramic green sheets are sintered at a predetermined temperature. Thus, the substrate is formed.

Thus, a microchemical chip having the channel provided with the uneven portion having the uneven wall surface on the downstream side in the flowing direction of the fluid to be treated from the position in which the supply portions are connected can be produced by forming the substrate in this manner.

The invention provides a method for producing a microchemical chip including a substrate in which a channel through which a fluid to be treated flows and a plurality of supply portions connected to the channel and from which a plurality of fluids to be treated are poured into the channel, respectively, are formed, and the channel has an uneven portion having an uneven wall surface on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:

forming a groove portion and forming unevenness on a predetermined wall surface of the groove portion by pressing a surface of a ceramic green sheet with a pattern having a predetermined shape;

sintering the ceramic green sheets in which the groove portion is formed at a predetermined temperature so as to form a substrate main body; and

covering the groove portion on the surface of the substrate main body with a covering member so as to form the substrate.

According to the invention, first, the groove portion is formed and unevenness is formed on the predetermined wall surface of the groove portion by pressing the surface of the ceramic green sheet with the pattern. Then, the ceramic green sheet in which the groove portion is formed is sintered at the predetermined temperature so as to form the substrate main body, and the groove portion exposed on the surface of the substrate main body is covered with the covering member. Thus, the substrate is formed. Thus, the channel having the uneven portion having the uneven wall surface is formed in the internal portion of the substrate.

A microchemical chip provided with the channel having the uneven portion having the uneven wall surface on the downstream side in the flowing direction of the fluid to be treated from the position in which the supply portions are connected can be produced by forming the substrate in this manner.

### BRIEF DESCRIPTION OF THE DRAWINGS

Other and further objects, features, and advantages of the invention will be more explicit from the following detailed description taken with reference to the drawings wherein:

FIG. 1A is a plan view showing a basic structure of a microchemical chip of the invention, and FIG. 1B is a cross-sectional view showing a cross-sectional structure taken along a sectional line I-I of the microchemical chip shown in FIG. 1A;

FIG. 2A is a plan view showing a simplified structure of a microchemical chip of a first embodiment of the invention, and FIG. 2B is cross-sectional views showing cross-sectional structures taken along sectional lines II-II, III-III, and IV-IV of the microchemical chip shown in FIG. 2A;

FIGS. 3A to 3C are plan views showing the states of the processed ceramic green sheets;

FIG. 4 is a cross-sectional view showing the state in which the ceramic green sheets are laminated;

FIG. 5A is a plan view showing a simplified structure of the microchemical chip of a second embodiment of the invention, and FIG. 5B is cross-sectional views showing cross-sectional structures taken along sectional lines V-V, VII-VII, and VIII-VIII of the microchemical chip shown in FIG. 5A;

FIGS. 6A and 6B are plan views showing the states of the processed ceramic green sheets;

FIG. 7 is a cross-sectional view showing the state in which the ceramic green sheets are laminated;

FIG. 8 is a plan view showing a simplified structure of a lid;

FIG. 9A is a plan view showing a simplified structure of the microchemical chip of a third embodiment of the invention, and FIG. 9B is cross-sectional views showing cross-sectional structures taken along sectional lines VIII-VIII, IX-IX, and X-X of the microchemical chip shown in FIG. 9A;

FIGS. 10A and 10B are plan views showing the states of the processed ceramic green sheets;

FIG. 11 is a cross-sectional view showing the state in which the ceramic green sheets are laminated;

FIG. 12 is a plan view showing a simplified structure of a lid;

FIG. 13A is a plan view showing a simplified structure of a microchemical chip of a fourth embodiment of the invention, and FIG. 13B is cross-sectional views showing cross-sectional structures taken along sectional lines XI-XI, XII-XII, and XIII-XIII of the microchemical chip shown in FIG. 13A;

FIGS. 14A to 14C are cross-sectional views showing an arrangement including a vibrating element X;

FIGS. 15A and 15B are plan views showing the states of the processed ceramic green sheets;

FIG. 16 is a cross-sectional view showing the state in which the ceramic green sheets are laminated;

FIG. 17 is a plan view showing a simplified structure of a lid 161;

FIG. 18A is a plan view showing a simplified structure of a microchemical chip of a fifth embodiment of the invention, and FIG. 18B is cross-sectional views showing cross-sectional structures taken along sectional lines XIV-XIV, XV-XV, and XVI-XVI of the microchemical chip shown in FIG. 18A;

FIGS. 19A to 19C are cross-sectional views showing the unevenness of a wall surface of an uneven portion taken along XVII-XVII of FIG. 18B;

FIGS. 20A and 20B are plan views showing the states of the processed ceramic green sheets;

FIG. 21 is a cross-sectional view showing the state in which the ceramic green sheets are laminated; and

FIG. 22 is a plan view showing a simplified configuration of a lid.

### DETAILED DESCRIPTION

Now referring to the drawings, preferred embodiments of the invention are described below.

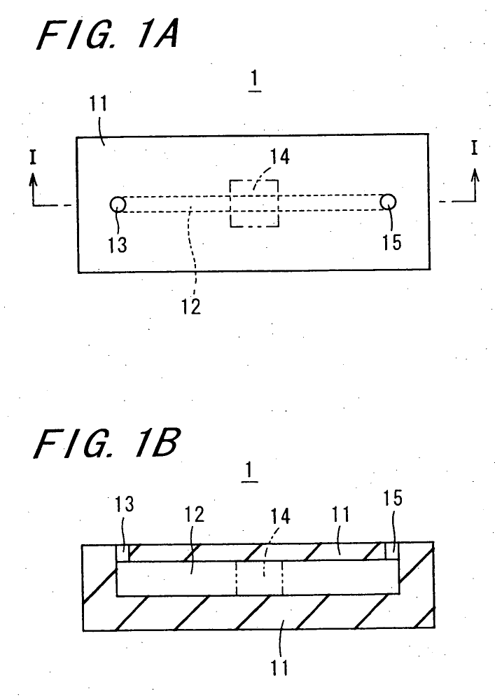

FIG. 1A is a plan view showing a basic structure of a microchemical chip 1 of the invention. FIG. 1B is a cross-sectional view showing a cross-sectional structure taken along a sectional line I-I of the microchemical chip 1 shown in FIG. 1A.

The microchemical chip 1 has a substrate 11 made of a ceramic material that is provided with a channel 12 through which a fluid to be treated flows, and a predetermined treatment is performed to the fluid to be treated that flows through the channel 12. The substrate 11 is provided with a supply portion 13 from which the fluid to be treated is poured into the channel 12, a treatment portion 14, and a collection portion 15 from which the treated fluid is drawn to the outside. The supply portion 13 is configured as an opening so that a fluid to be treated can be poured into the channel 12 from the outside. The collection portion 15 is configured as an opening so that a treated fluid can be removed from the channel 12 to the outside.

In microchemical chip 1, a fluid to be treated is poured from the supply portion 13 to channel 12, the poured fluid is subjected to a predetermined treatment in the treatment portion 14, and then the treated fluid is drawn from the collection portion 15 to the outside. For example, when a reagent is preliminarily fixed to the treatment portion 14, and a fluid including a substance is poured from the supply portion 13, then the substance and the reagent can be reacted in the treatment portion 14. Thus, a reaction product can be collected from the collection portion 15. Furthermore, when heating means such as a heater is provided below the channel 12 in the treatment portion 14, and the channel 12 in the treatment portion 14 is heated, then the substance and the reagent can be reacted more reliably.

As described above, the substrate 11 is made of a ceramic material, and therefore the substrate 11 having the channel 12 can be formed only by simple processing without performing complicated processing such as etching processing that is necessary when forming a channel in the substrate made of silicon, glass or resin. Therefore, the microchemical chip 1 has a high productivity and a low production cost, and therefore is inexpensive. In addition, the ceramic material has more excellent chemical resistance than that of resin or the like, so that the microchemical chip 1 can be used under various conditions. In other words, when the substrate 11 is made of a ceramic material, a microchemical chip 1 that has a high productivity, is inexpensive, has excellent chemical resistance, and can be used under various conditions can be obtained.

Examples of the ceramic material constituting the substrate 11 include aluminum oxide sintered substances, mullite sintered substances or glass ceramic sintered substances.

In the microchemical chip 1, when pouring a fluid to be treated from the supply portion 13, the fluid to be treated can be delivered from the supply portion 13 to collection portion 15 by forcing the fluid in with a microsyringe or the like. Alternatively, when pouring a fluid to be treated, the fluid to be treated can be delivered by pouring the fluid to be treated under application of pressure with a pump or the like provided outside. In addition, the fluid to be treated can be delivered by suction with a microsyringe or the like from the collection portion 15 after the fluid to be treated is poured from the supply portion 13.

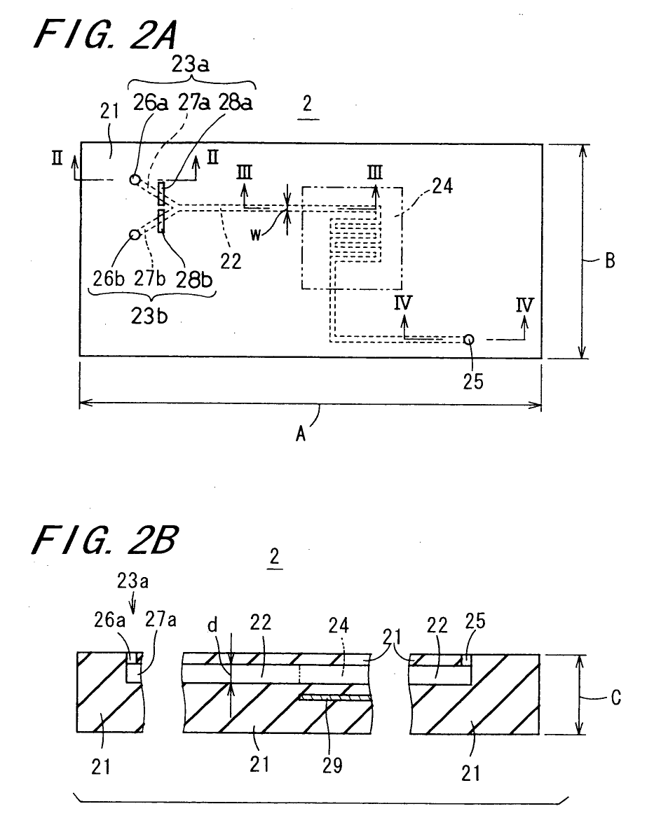

Next, the structure of the microchemical chip of the invention will be described more specifically. FIG. 2A is a plan view showing a simplified structure of a microchemical chip 2 of the first embodiment of the invention. FIG. 2B is cross-sectional views showing cross-sectional structures taken along sectional lines II-II, III-III, and IV-IV of the microchemical chip 2 shown in FIG. 2A. In FIG. 2B, the cross-sectional structures taken along the sectional lines II-II, III-III and IV-IV are shown in this order.

The microchemical chip 2 has a substrate 21 made of a ceramic material. The substrate 21 is provided with a channel 22, two supply portions 23a and 23b, a treatment portion 24, and a collection portion 25. The supply portion 23a includes a supply channel 27a, a supply ports 26a provided in an end portion of the supply channel 27a, and a micropump 28a provided above the supply channel 27a. Similarly, the supply portion 23b includes a supply channel 27b, a supply port 26b provided in an end portion of the supply channel 27b, and a micropump 28b provided above the supply channel 27b. The supply ports 26a and 26b are opened such that a fluid to be treated can be poured into the supply channels 27a and 27b from the outside. The collection portion 25 is configured as an opening such that a treated fluid is removed from the channel 22 to the outside.

A heater 29 is provided inside the substrate 21 below the channel 22 in the treatment portion 24. The channel 22 in the treatment portion 24 is formed in a meander manner such that the channel 22 can pass above the heater 29 a plurality of times. A conduction line (not shown) for connecting the heater 29 and an external power is drawn from the heater 29 on the surface of the substrate 21. This conduction line is formed of a metal material having a lower resistivity than that of the heater 29.

In the microchemical chip 2, fluids to be treated are poured from the two supply portions 23a and 23b to the channel 22 and are merged into one, and the channel 22 is heated at a predetermined temperature with the heater 29 in the treatment portion 24, if necessary, so that the two kinds of poured fluids to be treated are reacted, and then the obtained reaction product is drawn from the collection portion 25.

For example, a fluid containing a compound that is a raw material is poured from the supply portion 23a, and a fluid containing a reagent is poured from the supply portion 23b. Then, the channel 22 in the treatment portion 24 is heated with the heater 29. Then, a compound can be synthesized, and the obtained compound can be collected from the collection portion 25. Furthermore, in another embodiment different from this embodiment, when a detecting portion is provided in the collection portion 25 or on a upstream side in the flowing direction of the fluid to be treated from the collection portion 25, a reaction product of a chemical reaction or a biochemical reaction such as an antigen-antibody reaction and an enzyme reaction can be detected.

The microchemical chip 2 after use can be used again when the microchemical chip 2 is cleaned by pouring a cleaning liquid from the supply portions 23a and 23b.

The cross-section area of the channel 22 and the supply channels 27a and 27b is preferably 2.5×10⁻³ mm² or more and 1 mm² or less in order to efficiently deliver and mix specimens, reagents, or cleaning liquids poured from the supply portions 23a and 23b. When the cross-section area of the channel 22 and the supply channels 27a and 27b exceeds 1 mm², the amount of delivered specimen, reagent, or cleaning liquid becomes excessive, so that a reaction surface area per unit volume is increased, and therefore an effect of reducing the reaction time significantly of the microchemical chip cannot sufficiently be obtained. Furthermore, when the cross-section area of the channel 22 and the supply channels 27a and 27b is less than 2.5×10⁻³ mm², the loss of the pressure due to the micropumps 28a and 28b is increased, so that a problem is caused in delivering fluids. Therefore, it is preferable that the cross-section area of the channel 22 and the supply channels 27a and 27b is 2.5×10⁻³ mm² or more and 1 mm² or less.

The width w of the channel 22 and the supply channels 27a and 27b is preferably 50 to 1000 μm, more preferably 100 to 500 μm. The depth d of the channel 22 and the supply channels 27a and 27b is preferably 50 to 1000 μm, more preferably 100 to 500 μm, and within the preferable range of the cross-section area as described above. The relationship between the width (longer side) and the depth (shorter side) is preferably the length of the shorter side/the length of the longer side ≧0.4, more preferably the length of the shorter side/the length of the longer side ≧0.6. When the length of the shorter side/the length of the longer side <0.4, the pressure loss is large, which causes a problem in delivering fluids.

The outline size of the microchemical chip 1 is, for example, such that the width A is about 40 mm, the depth B is about 70 mm, and the height C is about 1 to 2 mm, but the invention is not limited thereto, and an appropriate outline size can be used, depending on the necessity.

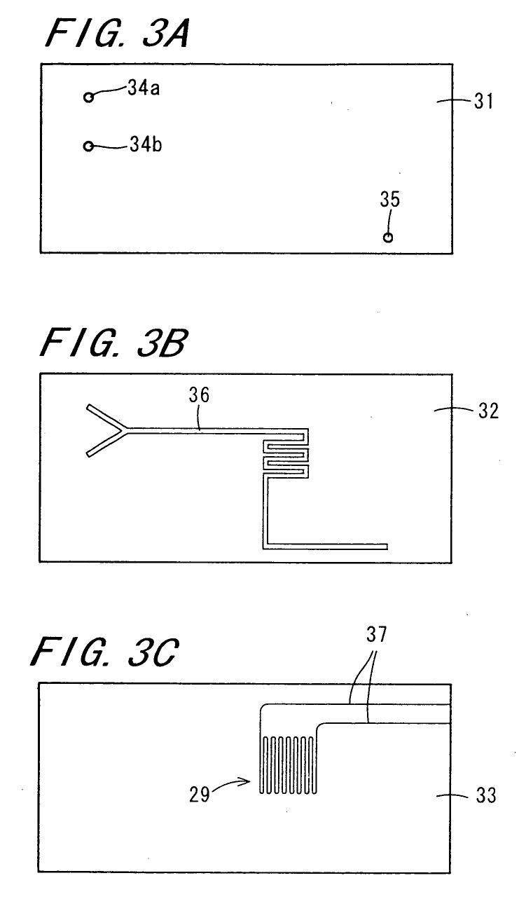

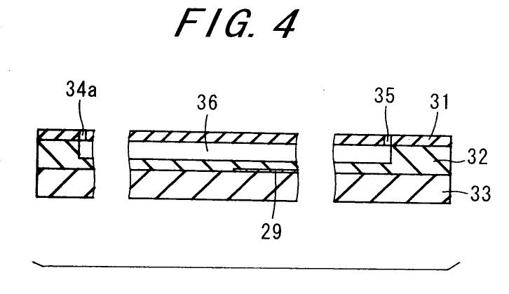

Next, a method for producing the microchemical chip 2 shown in FIGS. 2A and 2B will be described. FIGS. 3A to 3C are plan views showing the states of the processed ceramic green sheets 31, 32, and 33. FIG. 4 is a cross-sectional view showing the state in which the ceramic green sheets 31, 32 and 33 are laminated.

First, a suitable organic binder and solvent are mixed with a raw material powder, and if necessary, a plasticizer or a dispersant is added thereto, and the mixture is formed into a slurry. Then, the slurry is molded into a sheet by doctor blading, calendar rolling or the like. Thus, a ceramic green sheet (also referred to as “ceramic crude sheet”) is formed. As the raw material powder, for example, when the substrate 21 is made of an aluminum oxide sintered substance, aluminum oxide, silicon oxide, magnesium oxide, and calcium oxide or the like can be used.

In this embodiment, three of the thus formed ceramic green sheets are used. First, as shown in FIG. 3A, through-holes 34a, 34b and 35 that are in communication with a groove portion 36 formed in the second ceramic green sheet 32 shown in FIG. 3B are formed in the predetermined positions that become the supply ports 26a and 26b and the collection portion 25 in the first ceramic green sheet 31.

Next, as shown in FIG. 3B, the groove portion 36 is formed by pressing the surface of the second ceramic green sheet 32 with a pattern. In this case, as the pattern, a pattern having a shape to which a desired shape of the groove portion 36 is transferred is used. The pressing pressure for pressing the slurry with the pattern is adjusted depending on the viscosity of the slurry before being molded into the ceramic green sheet. For example, when the viscosity of the slurry is 1 to 4 Pa·s, a pressure of 2.5 to 7 MPa is applied to the slurry. There is no particular limitation regarding the material of the pattern, and a metal pattern or a wooden pattern can be used.

Next, as shown in FIG. 3C, the heater 29 and a wiring pattern 37 for external power connection are formed on the surface of the third ceramic green sheet 33 by applying a conductive paste in a predetermined shape by screen printing or the like. The conductive paste can be obtained by mixing a metal material powder such as tungsten, molybdenum, manganese, copper, silver, nickel, palladium, or gold with a suitable organic binder and solvent. For the conductive paste for forming the heater 29, a conductive paste in which 5 to 30 wt % of a ceramic powder is added to a metal material powder as described above such that a predetermined resistivity is achieved after firing, is used.

As shown in FIG. 4, the ceramic green sheet 32 in which the groove portion 36 is formed is laminated on the surface of the ceramic green sheet 33 in which the heater 29 is formed. Furthermore, the ceramic green sheet 31 in which the through-holes 34a, 34b and 35 shown in FIG. 3A are formed is laminated on the surface of the ceramic green sheet 32 such that the groove portion 36 is covered. The laminated ceramic green sheets 31, 32 and 33 are sintered at a temperature of about 1600° C. to be formed into a sintered integral piece.

Next, a piezoelectric material such as lead zirconate titanate (PZT; composition formula: Pb(Zr, Ti)O₃) is attached into a predetermined position on the surface side in which the through-holes 34a, 34b and 35 are formed so as to form the micropumps 28a and 28b. The piezoelectric material can vibrate the substrate 21 above the channel 22 by expanding or contracting in accordance with the applied voltage, and therefore serves as the micropumps 28a and 28b for delivering fluids.

In the manner described above, the substrate 21 shown in FIGS. 2A and 2B is formed so that the microchemical chip 2 can be obtained.

Thus, in the method for producing the microchemical chip 2 of this embodiment, after the groove portion 36 is formed on the surface of the ceramic green sheet 32, the ceramic green sheet 31 is laminated such that the groove portion 36 is covered, the laminated ceramic green sheets 31, 32, and 33 are fired to be formed into a sintered integral piece, and thus the substrate 21 having the channel 22 is formed. In other words, the microchemical chip 2 can be produced only by simple processing without performing complicated processing such as etching processing that is necessary when forming a channel in a substrate made of silicon, glass or resin. Therefore, the microchemical chip 2 has a high productivity and a low production cost, and therefore is inexpensive. Furthermore, in the method for producing the microchemical chip 2 of this embodiment, for the groove portion 36 that is to serve as the channel 22, a shape of a pressed pattern is transferred, so that the channel 22 whose bottom surface and side wall have desired surface shapes can be formed easily by adjusting the surface shape of the pattern.

As described above, although the microchemical chip 2 of this embodiment has two supply portions 23a and 23b, the invention is not limited thereto, and the microchemical chip 2 can have three or more supply portions.

When two or more supply portions are provided, it is not necessary that the supply channels of the supply portions are merged in one portion, but the supply channels can be connected to the channel 22 at different positions. The heater 29 is provided in one portion in this embodiment, but the invention is not limited thereto and two or more heaters can be provided. Thus, a complicated reaction can be controlled by providing three or more supply portions and two or more heaters.

It is not necessary to provide the heater 29 when a reaction can proceed without heating.

Furthermore, this embodiment is configured to have the micropumps 28a and 28b as means for delivering fluids, but it is possible to constitute so that the micropumps 28a and 28b are absent as in the case of the microchemical chip 1 shown in FIGS. 1A and 1B. In this case, similarly to the microchemical chip 1, when pouring fluids to be treated from the supply ports 26a and 26b, the fluids can be delivered from the supply ports 26a and 26b to the collection portion 25 by forcing the fluids in with a microsyringe or the like. Alternatively, when pouring fluids, the fluids can be delivered by pouring the fluid under application of pressure with a pump or the like provided outside. In addition, the fluids to be treated can be delivered by suction with a microsyringe or the like from the collection portion 25 after the fluids to be treated is poured from the supply ports 26a and 26b.

In the method for producing the microchemical chip 2 of this embodiment, when forming the substrate 21, another ceramic green sheet 31 is laminated on the surface of the ceramic green sheet 32 in which the groove portion 36 is formed such that the groove portion 36 is covered, and then the laminated ceramic green sheets 31, 32 and 33 are fired. However, the invention is not limited thereto, and the substrate can be formed by performing firing with the groove portion 36 exposed, and thereafter covering the groove portion 36 with a covering portion. In the thus formed substrate 21, a channel is formed with a substrate main body in which the groove portion 36 is formed and a covering portion that covers the groove portion 36.

As the covering portion, a lid made of glass or a ceramic material can be used. The lid is bonded onto the formed substrate main body, after the ceramic green sheets in which the groove portion 35 is formed are fired. The lid and the substrate main body are bonded, for example, by heating and pressing when the lid is made of glass, or bonded with a glass adhesive when the lid is made of a ceramic material. It should be noted that it is not always necessary to bond the lid to the substrate main body, but the lid can be provided removably from the substrate main body. For example, a structure where pressure is applied to the entire microchemical chip with a silicon rubber sandwiched by the substrate main body and the lid is possible. This structure in which the lid is removable from the substrate main body makes cleaning for reuse easy.

In the method for producing the microchemical chip 2 of this embodiment, the portion for the channel 22 of the substrate 21 is formed with two ceramic green sheets, that is, the ceramic green sheet 32 in which the groove portion 36 is formed and the ceramic green sheet 31 that is laminated such that the groove portion 36 is covered. However, the invention is not limited thereto, and the portion can be formed with three or more ceramic green sheets. In this case, the groove portion is formed in two or more ceramic green sheets, and a through-hole for communicating the groove portions formed in the different ceramic green sheets is formed.

For example, when the portion for the channel is formed with three ceramic green sheets, the substrate is formed in the following manner. First, in the same manner as in the ceramic green sheet 31 shown in FIG. 3A, a through-hole that is in communication with the groove portion to be formed in the second green sheet is formed in the first ceramic green sheet. Then, patterns having respective predetermined shapes are pressed onto the surfaces of the second and the third ceramic green sheets so as to form groove portions. Then, a through-hole in communication with the groove portions formed in the second and the third ceramic green sheets is formed in the second green sheet.

Next, another ceramic green sheet is laminated on the surface of the ceramic green sheet in which the groove portion 36 is formed in such a manner that the groove portion is covered. In other words, the second ceramic green sheet is laminated on the surface of the third ceramic green sheet in such a manner that the groove portion 36 formed in the third ceramic green sheet is covered. Then, the first ceramic green sheet is laminated on the surface of the second ceramic green sheet in such a manner that the groove portion 36 formed in the second ceramic green sheet is covered. In this case, each ceramic green sheet is laminated such that the groove portion 36 formed in the second ceramic green sheet is in communication with the groove portion 36 formed in the third ceramic green sheet via the through-hole formed in the second green sheet.

The thus laminated ceramic green sheets are sintered at a predetermined temperature in the same manner as in the case of forming the substrate 21, so that a substrate is formed. In the thus formed substrate, a channel is formed three-dimensionally.

The fluid to be treated flowing through the channel in a microchemical chip is a laminar flow, so that when channels are two-dimensionally connected to mix a plurality of fluids, the fluids are mixed only by diffusion, and a long distance is required for complete mixture. However, when channels in the vicinity of the junction portion on the downstream side are formed three-dimensionally, a turbulent flow is generated, which makes it possible to mix the plurality of fluids to be treated easily.

When the portion for the channel is formed with four ceramic green sheets, a groove portion is formed in the second and the fourth ceramic green sheets, and a through-hole for communicating the groove portions formed in the second and the fourth ceramic green sheets is formed in the first and the third ceramic green sheets. Then, the third, the second and the first ceramic green sheets are laminated in this order on the surface of the fourth ceramic green sheets, and then the ceramic green sheets are fired.

The piezoelectric material that serves as the micropumps 28a and 28b is attached after the laminated ceramic green sheets are fired. However, when a ceramic piezoelectric material such as PZT as described above is used, after the ceramic piezoelectric material is attached in a predetermined position in the ceramic green sheet 31, the piezoelectric material can be fired at the same time.

Furthermore, instead of the ceramic green sheet, a sheet made of resin can be used to produce a microchemical chip.

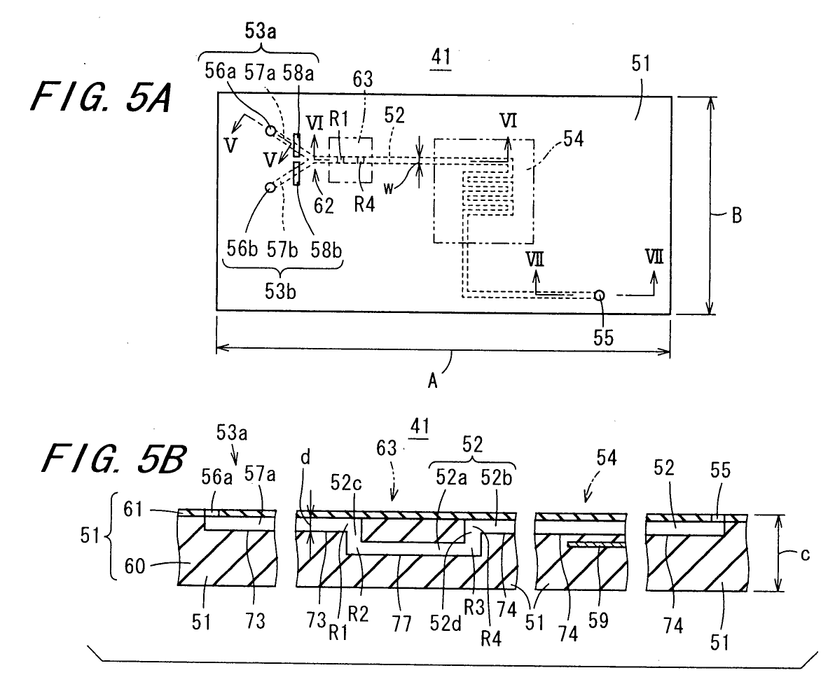

FIG. 5A is a plan view showing a simplified structure of a microchemical chip 41 of a second embodiment of the invention. FIG. 5B is cross-sectional views showing cross-sectional structures taken along sectional lines V-V, VII-VII, and VIII-VIII of the microchemical chip 41 shown in FIG. 5A. In FIG. 5B, the cross-sectional structures taken along the sectional lines VI-VI, VII-VII and VIII-VIII are shown in this order.

The microchemical chip 41 has a substrate 51 provided with a channel 52 through which a fluid to be treated flows, two supply portions 53a and 53b from each of which the fluid to be treated is poured into the channel 52, a treatment portion 54, and a collection portion 55 from which the treated fluid is drawn to the outside. The substrate 51 includes a substrate main body 60, on one surface side of which groove portions are formed, and a lid 61 that is a covering portion, and the channel 52 is formed by covering the surface of the substrate main body 60 provided with the groove portions 73 and 74 with the lid 61. The channel 52 has bend portions R1, R2, R3 and R4 in an area shown by reference numeral 63 on a downstream side in the flowing direction of the fluid to be treated from the position 62 where the supply portions 53a and 53b are connected. The bend portions R1 to R4 are formed by coupling two channels 52a and 52b having different distances from the surface of the substrate 51 via two channels 52c and 52d expending in the direction perpendicular to the surface of the substrate.

The supply portion 53a includes a supply channel 57a coupled to the channel 52, a supply port 56a provided in the end portion of the supply channel 57a, and a micropump 58a provided on an upstream side in the flowing direction of the fluid to be treated from the position 62 in which the channel 52 is connected. Similarly, the supply portion 53b includes a supply channel 57b, a supply port 56b, and a micropump 58b. The supply ports 56a and 56b are opened such that a fluid to be treated can be poured into the supply channels 57a and 57b from the outside. The collection portion 55 is configured as an opening such that a fluid to be treated is removed from the channel 52 to the outside.

A heater 59 is provided inside the substrate main body 70 below the channel 52 in the treatment portion 54. The channel 52 in the treatment portion 54 is formed with bending, for example, in a winding manner, such that the channel 52 can pass above the heater 59 a plurality of times. A conduction line (not shown) for connecting the heater 59 and an external power is drawn from the heater 59 on the surface of the substrate 51. This conduction line is formed of a metal material having a lower resistivity than that of the heater 59.

In the microchemical chip 41, two kinds of fluids to be treated are poured from the two supply portions 53a and 53b to the channel 52 and are merged into one, and the channel 52 is heated at a predetermined temperature with a heater 59 in the treatment portion 54, if necessary, so that the two kinds of poured fluids to be treated are reacted, and then the obtained reaction product is drawn from the collection portion 55.

The cross-section area of the channel 52 and the supply channels 57a and 57b is preferably 2.5×10⁻³ mm² or more and 1 mm² or less in order to efficiently deliver and mix specimens, reagents, or cleaning liquids poured from the supply portions 53a and 53b. However, the fluid flowing through the channel having a cross-section area of about 2.5×10⁻³ mm² to 1 mm² generally flows in a state of a laminar flow, so that simply connecting the two supply channels 57a and 57b allows the two fluids that are poured into the channel 52 from the supply portions 53a and 53b and merged to be mixed only by diffusion. Therefore, it is necessary to provide a long channel in order to mix the merged two fluids fully, which limits the achievement of a compact microchemical chip.

On the other hand, in this embodiment, the channel 52 in the area 63 in which the merged two fluids poured from the supply portions 53a and 53b flow has the bend portions R1 to R4, as described above, and therefore a turbulent flow can be generated when the merged fluids pass through the bend portions R1 to R4. Thus, the merged fluids can be mixed efficiently, and the channel 52 necessary for mixture can be short. Therefore, a microchemical chip 41 in which a plurality of fluids to be treated can be mixed efficiently can be realized without increasing the size of the structure. Thus, the size of a microchemical system using a microchemical chip can be reduced.

In this embodiment, since the channel 52 has the bend portions R1 to R4 in the area 63 on the upstream side in the flowing direction of the fluid to be treated from the treatment portion 54, the merged fluids to be treated are mixed sufficiently when the fluids have reached the treatment portion 54. Therefore, for example, when pouring a compound that is a raw material from the supply portion 53a, pouring a reagent from the supply portion 53b, merging the compound and the reagent and heating the merged compound and reagent with the heater 59 in the treatment portion 54 to cause a reaction, then the compound and the reagent can be heated with being mixed sufficiently. Consequently, the compound and the reagent can be reacted efficiently and the yield of a reaction product that can be collected from the collection portion 55 can be improved.

As described above, the bend portions R1 to R4 of the channel 52 are formed by coupling the two channels 52a and 52b having different distances from the surface of the substrate 51 via the two channels 52c and 52d expending in the direction perpendicular to the surface of the substrate. More specifically, the bend portions R1 to R4 are not formed on a plane parallel to the surface of the substrate 51, but formed three-dimensionally in the internal portion of the substrate 51. Therefore, the channel 52 in the area 63 is formed three-dimensionally with bending. In this case, compared with the case where the channel 52 is formed two-dimensionally with bending in the area 63 by forming the bend portions two-dimensionally on a plane parallel to the surface of the substrate 51, the area taken up by the projected image of the channel 52 that is bent in the area 63 can be reduced on the surface of the substrate. Thus, the size of the microchemical chip 41 can be reduced more.

As the substrate main body 60, a substrate made of a ceramic material, silicon, glass or resin can be used, and among these, it is preferable to use a substrate made of a ceramic material. The ceramic materials have excellent chemical resistance, compared with resin or the like, so that when the substrate main body 60 is made of a ceramic material, a microchemical chip 41 that has excellent chemical resistance and that can be used under various conditions can be obtained. Examples of the ceramic material constituting the substrate main body 60 include aluminum oxide sintered substances, mullite sintered substances or glass ceramic sintered substances.

The lid 61 can be formed of glass or a ceramic material, but it is preferable to use glass for the lid 61 because the mixture state or the reaction state of the fluid to be treated can be confirmed.

For the same reason as that of the first embodiment, the cross-section area of the channel 52 and the supply channels 57a and 57b is preferably 2.5×10⁻³ mm² or more and 1 mm² or less in order to efficiently deliver and mix specimens, reagents, or cleaning liquids poured from the supply portions 53a and 53b.

Like the first embodiment, the width w of the channel 52 and the supply channels 57a and 57b is preferably 50 to 1000 μm, more preferably 100 to 500 μm. Like the first embodiment, the depth d of the channel 52 and the supply channels 57a and 57b is preferably 50 to 1000 μm, more preferably 100 to 500 μm, and within the preferable range of the cross-section area as described above. Like the first embodiment, the relationship between the width (longer side) and the depth (shorter side) is preferably the length of the shorter side/the length of the longer side ≧0.4, more preferably the length of the shorter side/the length of the longer side ≧0.6. When the length of the shorter side/the length of the longer side <0.4, the pressure loss is large, which causes a problem in delivering fluids.

Like the first embodiment, the outline size of the microchemical chip 41 is, for example, such that the width A is about 40 mm, the depth B is about 70 mm, and the height C is about 1 to 2 mm, but the invention is not limited thereto, and an appropriate outline size can be used, depending on the necessity.

The microchemical chip 41 after use can be used again when the microchemical chip is cleaned by pouring a cleaning liquid from the supply portions 53a and 53b.

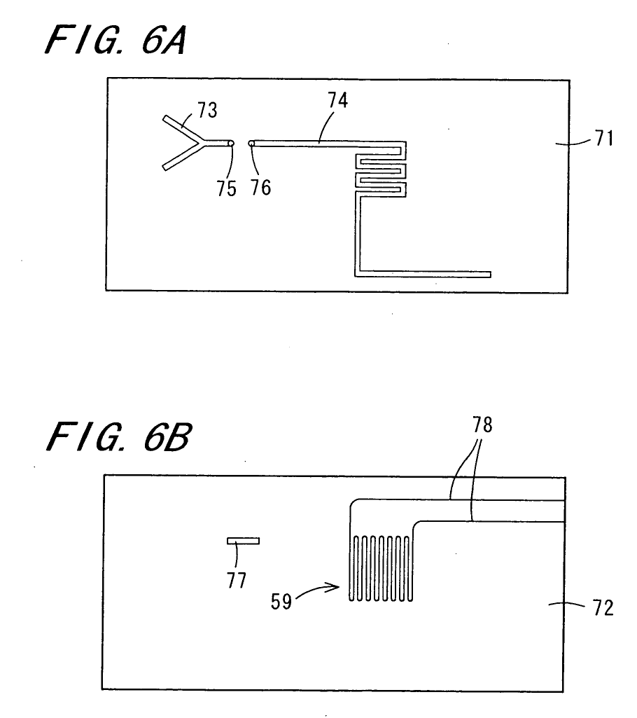

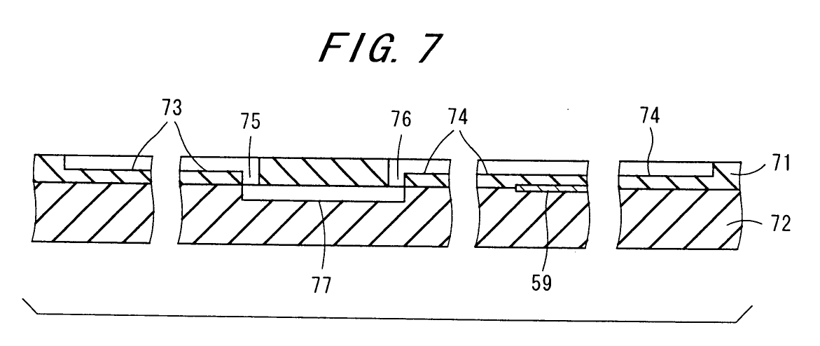

Next, a method for producing the microchemical chip 41 shown in FIGS. 5A and 5B will be described. In this embodiment, the case where the substrate main body 60 is made of a ceramic material will be described. FIGS. 6A and 6B are plan views showing the states of the processed ceramic green sheets 71 and 72. FIG. 7 is a cross-sectional view showing the state in which the ceramic green sheets 71 and 72 are laminated.

First, a suitable organic binder and solvent are mixed with a raw material powder, and if necessary, a plasticizer or a dispersant is added thereto, and the mixture is formed into a slurry. Then, the slurry is molded into a sheet by doctor blading, calendar rolling or the like. Thus, a ceramic green sheet (also referred to as “ceramic crude sheet”) is formed. As the raw material powder, for example, when the substrate main body 60 is made of an aluminum oxide sintered substance, aluminum oxide, silicon oxide, magnesium oxide, and calcium oxide or the like can be used.

In this embodiment, two of the thus formed ceramic green sheets are used to form the substrate main body 60. First, as shown in FIG. 6A, groove portions 73, 74 are formed by pressing the surface of the first ceramic green sheet 71 with a pattern. Furthermore, as shown in FIG. 6B, a groove portion 77 is formed by pressing the surface of the second ceramic green sheet 72 with a pattern. In this case, as the pattern for the ceramic green sheet 71, a pattern having a shape to which desired shapes of the groove portions 73 and 74 are transferred is used, and as the pattern for the ceramic green sheet 72, a pattern having a shape to which a desired shape of the groove portion 77 is transferred is used. The pressing pressure for pressing the slurry with the pattern is adjusted depending on the viscosity of the slurry before being molded into the ceramic green sheet. For example, when the viscosity of the slurry is 1 to 4 Pa·s, a pressure of 2.5 to 7 MPa is applied to the slurry. There is no particular limitation regarding the material of the pattern, and a metal pattern or a wooden pattern can be used.

Furthermore, as shown in FIG. 6A, through-holes 75 and 76 for communicating the groove portions 73 and 74 in the ceramic green sheet 71 and the groove portion 77 in the ceramic green sheet 72 are formed in the ceramic green sheet 71. The through-holes 75 and 76 can be formed by stamping the ceramic green sheet 71 with a punch. Alternatively, the through-holes 75 and 76 can be formed, using a laser or a microdrill or the like. These through-holes 75 and 76 correspond to the channels 52c and 52d extending in the direction perpendicular to the surface of the substrate.

Next, as shown in FIG. 6B, the heater 59 and a wiring pattern 78 for external power connection are formed on the surface of the ceramic green sheet 72 in which the groove portion 77 is formed by applying a conductive paste in a predetermined shape by screen printing or the like. The conductive paste can be obtained by mixing a metal material powder such as tungsten, molybdenum, manganese, copper, silver, nickel, palladium, or gold with a suitable organic binder and solvent. For the conductive paste for forming the heater 59, a conductive paste in which 5 to 30 wt % of a ceramic powder is added to a metal material powder as described above such that a predetermined resistivity is achieved after firing is used.

As shown in FIG. 7, the ceramic green sheet 71 in which the groove portions 73 and 74 are formed is laminated on the surface of the ceramic green sheet 72 in which the groove portion 77 is formed. In this case, the lamination is performed such that the groove portion 77 in the ceramic green sheet 72 is covered with the ceramic green sheet 71 and that the groove portions 73 and 74 in the ceramic green sheet 71 is in communication with the groove portion 77 in the ceramic green sheet 72 via the through-holes 75 and 76 formed in the ceramic green sheet 71. The laminated ceramic green sheets 71 and 72 are sintered at a temperature of about 1600° C. Thus, the substrate main body 60 shown in FIGS. 5A and 5B can be formed.

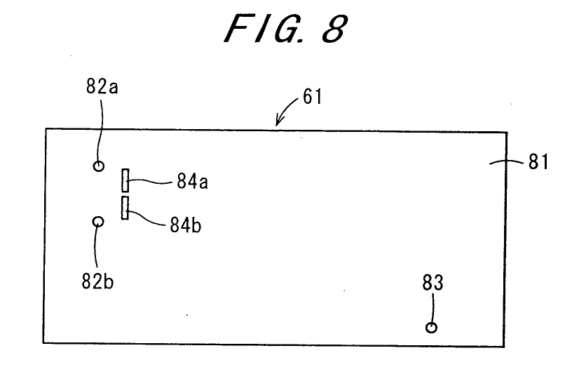

FIG. 8 is a plan view showing a simplified structure of the lid 61. As shown in FIG. 8, the through-holes 82a and 82b that are in communication with the groove portion 73 and the through-hole 83 that is in communication with the groove portion 74 of ceramic green sheet 71 shown in FIG. 6A are formed in the predetermined positions that are to serve as the supply ports 56a and 56b and the collection portion 55 in the substrate 81 made of, for example, glass or a ceramic material, and thus the lid 61 can be obtained.

The lid 61 is bonded onto the surface on which the groove portions 73 and 74 are exposed of the substrate main body 60. For example, the lid 61 and the substrate main body 60 are bonded by heating and pressing when the lid 61 is made of glass, and are bonded with a glass adhesive when the lid 61 is made of a ceramic material.

Next, piezoelectric materials 84a and 84b such as lead zirconate titanate (PZT; composition formula: Pb(Zr, Ti)O₃) are attached into predetermined positions on the surface of the lid 61, and conduction lines (not shown) for applying a voltage to the piezoelectric materials 84a and 84b are formed. The piezoelectric materials 84a and 84b can vibrate the lid 61 above the supply channels 57a and 57b by expanding or contracting in accordance with the applied voltage, and therefore micropumps 58a and 58b for delivering fluids can be formed by attaching the piezoelectric materials 84a and 84b to the lid 61 above the supply channels 57a and 57b.

In the manner described above, the substrate 51 shown in FIGS. 5A and 5B is formed so that the microchemical chip 41 can be obtained. Thus, the three-dimensional channel 52 in which the plurality of channels 52a and 52b having different distances from the surface of the substrate 51 are coupled to the channels 52c and 52d expending in the direction perpendicular to the surface of the substrate is formed in the internal portion of the substrate 51, so that the microchemical chip 41 in which the channel 12 is bent in the area 63 on the downstream side in the flowing direction of the fluid to be treated from the position 62 where the supply portions 53a and 53b are connected can be obtained.

In this embodiment, the substrate main body 60 is formed by forming the groove portions 73, 74 and 77 by pressing the surface of the ceramic green sheets 71 and 72 with a pattern, laminating the ceramic green sheet 71 such that the groove portion 77 is covered, and sintering the laminated ceramic green sheets 71 and 72, and the groove portions 73 and 74 on the surface of the substrate main body 60 is covered with the lid 61, and thus the substrate 51 having the channel 52 is formed. Therefore, the microchemical chip 41 can be produced only by simple processing without performing complicated processing such as etching processing that is necessary when forming a channel in a substrate made of silicon, glass or resin.

As described above, although the microchemical chip 41 of this embodiment has two supply portions 53a and 53b, the invention is not limited thereto, and the microchemical chip 41 can have three or more supply portions. When two or more supply portions are provided, it is not necessary that the supply channels of the supply portions are merged in one portion, but the supply channels can be connected to the channel 52 at different positions. In this case, it is preferable that the channel on the downstream side in the flowing direction of the fluid to be treated from the position in which the supply portions are connected is bent in the same manner as the channel 52 in the area 63 shown in FIGS. 5A and 5B.

The heater 59 is provided in one portion in this embodiment, but the invention is not limited thereto and two or more heaters can be provided. Thus, a complicated reaction can be controlled by providing three or more supply portions and two or more heaters. It is not necessary to provide the heater 59 when a reaction can proceed without heating.

In this embodiment, the channel 52 in the area 63 on the downstream side in the flowing direction of the fluid to be treated from the position 62 in which the supply portions 53a and 53b are connected is bent by coupling two channels 52a and 52b having different distances from the surface of the substrate 51, but the invention is not limited thereto, and the channel 52 can be bent by coupling three or more channels having different distances from the surface of the substrate 51. Furthermore, similarly to the channel 52 in the treatment portion 54, the channel can be bent on a plane parallel to the surface of the substrate 51. The area in which the channel 52 is bent is not limited to the area 63.

In this embodiment, the channel 52 in the treatment portion 54 on the downstream side in the flowing direction of the fluid to be treated also has a bend portion. Therefore, even if the channel 52 is not bent in the area 63, a turbulent flow is generated in the merged fluids when the fluids flow through the channel 52 in the treatment portion 54, so that the fluids can be mixed efficiently. However, in order to sufficiently increase the efficiency of the reaction in the treatment portion 54, it is preferable to form a bend portion in the channel 52 on the upstream side in the flowing direction of the fluid from the treatment portion 54, as in this embodiment.

In the microchemical chip 41 of this embodiment, the collection portion 55 is provided and a reaction product is drawn from the collection portion 55. However, when a detecting portion is provided in the collection portion 55 or on the upstream side in the flowing direction of the fluid to be treated from the collection portion 55, a reaction product of a chemical reaction or a biochemical reaction such as an antigen-antibody reaction and an enzyme reaction can be detected. In this case, it is preferable to form a bend portion in the channel 52 on the upstream side in the flowing direction of the fluid to be treated from the detecting portion.

Furthermore, this embodiment is configured to have the micropumps 58a and 58b as means for delivering fluids, but it is possible to constitute so that the micropumps 58a and 58b are absent. In this case, when pouring fluids to be treated from the supply ports 56a and 56b, the fluids can be delivered from the supply ports 56a and 56b to the collection portion 55 by forcing the fluids in with a microsyringe or the like. Alternatively, when pouring the fluids, the fluids can be delivered by pouring the fluids under application of pressure with a pump or the like provided outside. In addition, the fluids to be treated can be delivered by suction with a microsyringe or the like from the collection portion 55 after the fluid to be treated is poured from the supply ports 56a and 56b.

In the method for producing the microchemical chip 41 of this embodiment, the substrate main body 60 is formed with two ceramic green sheets, that is, the ceramic green sheet 71 in which the groove portions 73 and 74 and the through-holes 75 and 76 are formed and the ceramic green sheet 72 in which the groove portion 77 is formed. However, the invention is not limited thereto, and the substrate main body 60 can be formed with three or more ceramic green sheets. For example, when the substrate main body 60 is formed in such a manner that a ceramic green sheet in which a through-hole is formed is laminated between the ceramic green sheets 71 and 72, and the groove portions 73 and 74 in the ceramic green sheet 71 is in communication with the groove portion 77 in the ceramic green sheet 72 via the through-hole in this ceramic green sheet and the through-hole in the ceramic green sheet 71, then the channel 52a can be formed in a position deeper from the surface of the substrate 51.

In the method for producing microchemical chip 41 of this embodiment, the substrate 51 is formed by firing with the groove portions 73 and 74 on the surface of the ceramic green sheet 71 exposed to form the substrate main body 60 and then covering the groove portions 73 and 74 on the surface of the substrate main body 60 with the lid 61. However, the invention is not limited thereto. The substrate 51 can be formed by laminating a ceramic green sheet provided with the same through-hole as in the lid 61 that is in communication with the groove portions 73 and 74 on the surface of the ceramic green sheet 71 and firing the ceramic green sheets. When the substrate is formed in this manner, it is not necessary to attach the lid 61 after the substrate main body 60 is formed, so that the productivity can be improved. In the case where a ceramic material such as PZT as described above is used for the piezoelectric materials 84a and 84b constituting the micropumps 58a and 58b, after the ceramic piezoelectric material is attached in a predetermined position in the ceramic green sheet in which the through-holes in communication with the groove portions 73 and 74 are formed, the piezoelectric material can be fired at the same time.

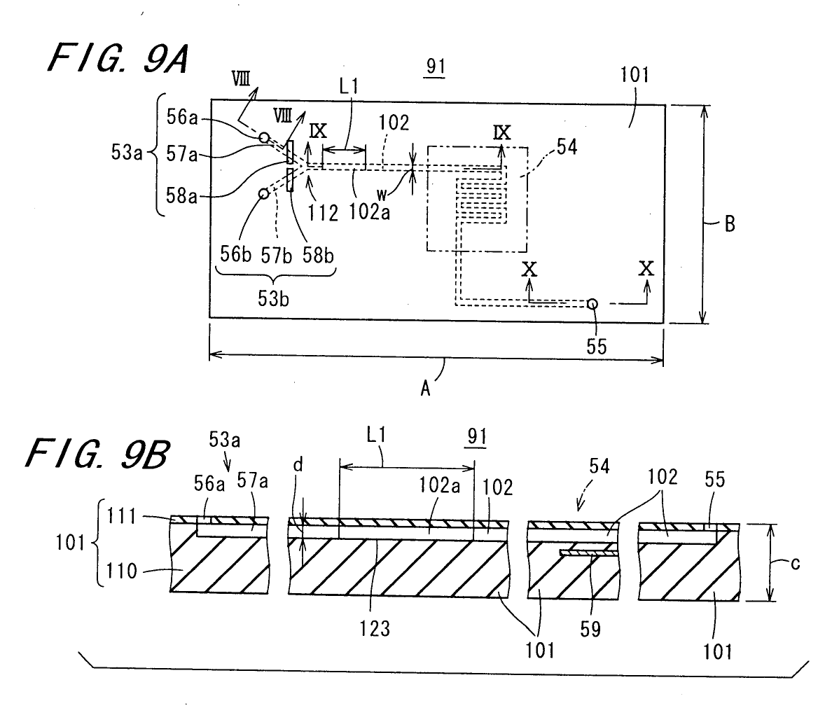

FIG. 9A is a plan view showing a simplified structure of a microchemical chip 91 of a third embodiment of the invention. FIG. 9B is cross-sectional views showing cross-sectional structures taken along sectional lines VIII-VIII, IX-IX, and X-X of the microchemical chip 91 shown in FIG. 9A. In FIG. 9B, the cross-sectional structures taken along the sectional lines VIII-VIII, IX-IX and X-X are shown in this order. In this embodiment, the same components as those of the aforementioned embodiment will be denoted by the same reference numerals, and it will be omitted to describe in detail.

The microchemical chip 91 has a substrate 101 provided with a channel 102 through which a fluid to be treated flows, two supply portions 53a and 53b from each of which the fluid to be treated is poured into the channel 102, a treatment portion 54, and a collection portion 55 from which the treated fluid is drawn to the outside. The substrate 101 includes a substrate main body 110, on one surface of which groove portions are formed, and a lid 111 that is a covering portion, and the channel 102 is formed by covering the surface of the substrate main body 110 provided with the groove portion 123 with the lid 111. In this microchemical chip 91, the channel 102 has a hydrophilic portion 102a having a hydrophilic wall surface (or a hydrophobic portion 102a having a hydrophobic wall surface) with a length L1 on a downstream side from a position 112 in which the supply portions 53a and 53b are connected.

The heater 59 is provided inside the substrate main body 110 below the channel 102 in the treatment portion 54.

In the microchemical chip 91, two kinds of fluids to be treated are poured from the two supply portions 53a and 53b to the channel 102 and are merged into one, and the channel 102 is heated at a predetermined temperature with a heater 59 in the treatment portion 54, if necessary, so that the two poured fluids to be treated are reacted, and then the obtained reaction product is drawn from the collection portion 55.

The cross-section area of the channel 102 and the supply channels 57a and 57b is preferably 2.5×10⁻³ mm² or more and 1 mm² or less in order to efficiently deliver and mix specimens, reagents, or cleaning liquids poured from the supply portions 53a and 53b. However, the fluid flowing through the channel having a cross-section area of about 2.5×10⁻³ mm² to 1 mm² generally flows in a state of a laminar flow, so that simply connecting the two supply channels 57a and 57b allows the two kinds of fluids that are poured into the channel 102 from the supply portions 53a and 53b and merged to be mixed only by diffusion. Therefore, it is necessary to provide a long channel in order to mix the merged two kinds of fluids fully, which limits the achievement of a compact microchemical chip.

On the other hand, in this embodiment, the channel 102 has the hydrophilic portion 102a having the hydrophilic wall surface (or the hydrophobic portion 102a having the hydrophobic wall surface) with the length L1 on the downstream side from the position 112 in which the supply portions 53a and 53b are connected to the channel 102. Therefore, when a plurality of fluids to be treated pass through the hydrophilic portion 102a having the hydrophilic wall surface (or the hydrophobic portion 102a having the hydrophobic wall surface) after being merged into one, a turbulent flow is generated in the merged fluids to be treated. This is because the fluids pass through channel portions whose wall surfaces have different properties. For example, when merging hydrophilic fluids to be treated, the wall surface of the channel portion 102a on the downstream side is formed so as to be more hydrophobic than the wall surface of the channel portion on the upstream side from that portion. When merging hydrophobic fluids to be treated, the wall surface of the channel portion 102a on the downstream side is formed so as to be more hydrophilic than the wall surface of the channel portion on the upstream side from that portion.

Thus, a plurality of fluids to be treated can be mixed by generating a turbulent flow in the merged fluids to be treated. Consequently, compared with the case where fluids are mixed only by diffusion, a plurality of fluids to be treated can be mixed sufficiently in a short channel. Therefore, since the length of the channel 102 can be reduced, the size of the microchemical chip 91 can be reduced, and the size of a microchemical system using the microchemical chip 91 can be reduced. Furthermore, since a predetermined treatment is performed in a state where a plurality of fluids to be treated are mixed sufficiently, the predetermined treatment can be performed more reliably than in the case where mixture is not adequate.

In this embodiment, the channel 102 has the hydrophilic portion 102a having the hydrophilic wall surface (or the hydrophobic portion 102a having the hydrophobic wall surface) between the junction position 112 and the treatment portion 54. Therefore, the merged fluids to be treated are mixed sufficiently when the fluids have reached the treatment portion 54. Therefore, for example, when pouring a compound that is a raw material from the supply portion 53a, pouring a reagent from the supply portion 53b, merging the compound and the reagent and heating the merged compound and reagent with the heater 59 in the treatment portion 54 to cause a reaction, the compound and the reagent can be heated with being mixed sufficiently. Consequently, the compound and the reagent can be reacted efficiently and the yield of a reaction product that can be collected from the collection portion 55 can be improved.

As the substrate main body 110, like the substrate main body 60 of the above-mentioned embodiments, a substrate made of a ceramic material, silicon, glass or resin can be used, and among these, it is preferable to use a substrate made of a ceramic material.

As the lid 111, a lid made of glass or a ceramic material can be used, but it is preferable to use glass for the lid 111 because the mixture state or the reaction state of the fluid to be treated can be confirmed.

For the same reason as that of the above-mentioned embodiments, the cross-section area of the channel 102 and the supply channels 57a and 57b is preferably 2.5×10⁻³ mm² or more and 1 mm² or less in order to efficiently deliver and mix specimens, reagents, or cleaning liquids poured from the supply portions 53a and 53b.

Like the above-mentioned embodiments, the width w of the channel 102 and the supply channels 57a and 57b is preferably 50 to 1000 μm, more preferably 100 to 500 μm. Like the above-mentioned embodiments, the depth d of the channel 102 and the supply channels 57a and 57b is preferably 50 to 1000 μm, more preferably 100 to 500 μm.

Like the above-mentioned embodiments, the outline size of the microchemical chip 91 is, for example, such that the width A is about 40 mm, the depth B is about 70 mm, and the height C is about 1 to 2 mm, but the invention is not limited thereto, and an appropriate outline size can be used, depending on the necessity.

The microchemical chip 91 after use can be used again when the microchemical chip is cleaned by pouring a cleaning liquid from the supply portions 53a and 53b.

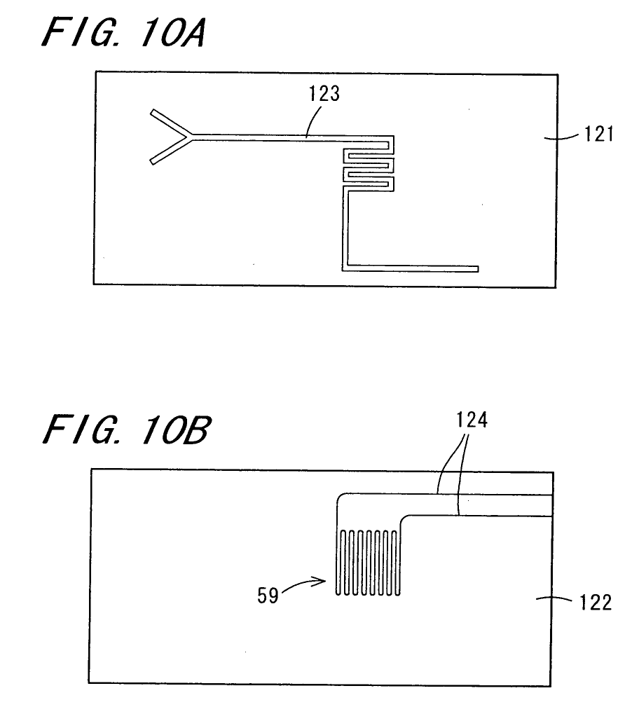

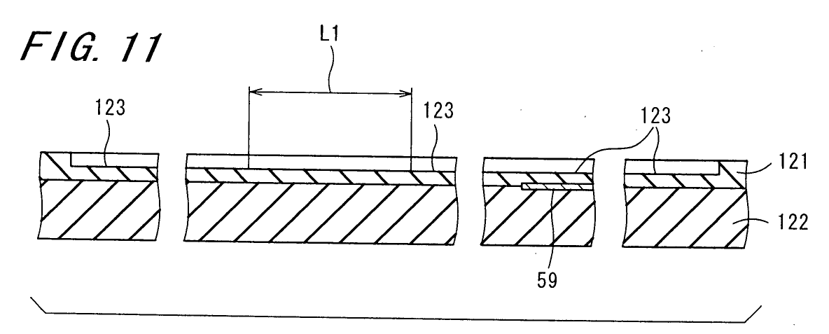

Next, a method for producing the microchemical chip 91 shown in FIGS. 9A and 9B will be described. In this embodiment, the case where the substrate main body 110 is made of a ceramic material will be described. FIGS. 10A and 10B are plan views showing the states of the processed ceramic green sheets 121 and 122. FIG. 11 is a cross-sectional view showing the state in which the ceramic green sheets 121 and 122 are laminated.

First, a suitable organic binder and solvent are mixed with a raw material powder, and if necessary, a plasticizer or a dispersant is added thereto, and the mixture is formed into a slurry. Then, the slurry is molded into a sheet by doctor blading, calendar rolling or the like. Thus, a ceramic green sheet (also referred to as “ceramic crude sheet”) is formed. As the raw material powder, for example, when the substrate 110 is made of an aluminum oxide sintered substance, aluminum oxide, silicon oxide, magnesium oxide, and calcium oxide or the like can be used.

In this embodiment, two of the thus formed ceramic green sheets are used to form the substrate main body 110. First, as shown in FIG. 10A, a groove portion 123 is formed by pressing the surface of the ceramic green sheet 121 with a pattern. In this case, a pattern having a shape to which desired shape of the groove portion 123 is transferred is used. The pressing pressure for pressing the slurry with the pattern is adjusted depending on the viscosity of the slurry before being molded into the ceramic green sheet. For example, when the viscosity of the slurry is 1 to 4 Pa·s, a pressure of 2.5 to 7 MPa is applied to the slurry. There is no particular limitation regarding the material of the pattern, and a metal pattern or a wooden pattern can be used.

Next, as shown in FIG. 10B, the heater 59 and a wiring pattern 124 for external power connection are formed on the surface of the ceramic green sheet 123 by applying a conductive paste in a predetermined shape by screen printing or the like. The conductive paste can be obtained by mixing a metal material powder such as tungsten, molybdenum, manganese, copper, silver, nickel, palladium, or gold with a suitable organic binder and solvent. For the conductive paste for forming the wiring pattern 124 that is to serve as the heater 59, a conductive paste in which 5 to 30 wt % of a ceramic powder is added to a metal material powder as described above such that a predetermined resistivity is achieved after firing is used.

As shown in FIG. 11, the ceramic green sheet 121 in which the groove portion 123 is formed is laminated on the surface of the ceramic green sheet 122 in which the wiring pattern 124 that is to serve as the heater 59 is formed. The laminated ceramic green sheets 121 and 122 are sintered at a temperature of about 1600° C. In the manner described above, the substrate main body 110 shown in FIGS. 9A and 9B is formed.

The wall surface of the groove portion 123 with the length L1 that is to serve as the channel portion 102a on the downstream side from the junction position 112 in which the channel 102 is connected to the supply portions 53a and 53b is allowed to be a hydrophilic wall surface or a hydrophobic wall surface by subjecting the thus formed substrate main body 110 to the following treatment.

(1) In the Case where the Wall Surface of the Channel Portion 102a is Allowed to be Hydrophilic

(1-a) When the substrate main body 110 is hydrophilic, a wall surface of the groove portion 123 with the length L1 that is desired to be hydrophilic of the wall surface of the groove portion 123 is covered with a protective film, and then a treatment for providing hydrophobicity is performed with respect to the wall surface excluding the desired wall surface. Then, the protective film is removed, and thus the desired wall surface is allowed to be hydrophilic.

(1-b) When the substrate main body 110 is hydrophobic, the portions excluding a wall surface of the groove portion 123 with the length L1 that is desired to be hydrophilic of the wall surface of the groove portion 123 are covered with a protective film, and then a treatment for providing hydrophilicity is performed with respect to the desired wall surface. Then, the protective film is removed, and thus the desired wall surface is allowed to be hydrophilic.

(2) In the Case where the Wall Surface of the Channel Portion 102a is Allowed to be Hydrophobic

(2-a) When the substrate main body 110 is hydrophilic, the portions excluding a wall surface of the groove portion 123 with the length L1 that is desired to be hydrophobic of the wall surface of the groove portion 123 are covered with a protective film, and then a treatment for providing hydrophobicity is performed to the desired wall surface. Then, the protective film is removed, and thus the desired wall surface is allowed to be hydrophobic.

(2-b) When the substrate main body 110 is hydrophobic, a wall surface of the groove portion 123 with the length L1 that is desired to be hydrophobic of the wall surface of the groove portion 123 is covered with a protective film and then a treatment for providing hydrophilicity is performed to the wall surface excluding the desired wall surface. Then, the protective film is removed, and thus the desired wall surface is allowed to be hydrophobic.

The treatment for providing hydrophilicity can be performed by immersing the substrate main body 110 whose desired wall surface or wall surface excluding the desired wall surface is covered with a protective film in an alcohol for about 30 seconds, removing the substrate main body, and then washing the same with water. By immersing the substrate main body in an alcohol, hydroxyl groups (—OH) can be introduced to the desired wall surface of the substrate main body 110 made of a ceramic material. As the alcohol, for example, isopropyl alcohol (abbreviated as IPA) can be used.

The treatment for providing hydrophobicity can be performed by immersing the substrate main body 110 whose desired wall surface or wall surface excluding the desired wall surface is covered with a protective film in a surfactant solution for about 30 seconds, removing the substrate main body, and then washing the same with water, preferably, warm water. By immersing the substrate main body in a surfactant solution, hydroxyl groups (—OH) present on the desired wall surface of the substrate main body 110 made of a ceramic material can be removed. As the surfactant solution, for example, alkylene glycol based nonionic surfactants, alkyl phenyl glycol based nonionic surfactants, fluorine-containing alkylene glycol based nonionic surfactants or silicon-containing alkylene glycol based nonionic surfactants can be used.

For example, in order to allow the wall surface of the channel portion 102a provided in the hydrophobic substrate main body 110 to be hydrophilic, the portion excluding the wall surface desired to be hydrophilic of the wall surface of the groove portion 123 is covered with a protective film, and then the desired wall surface is subjected to a treatment for providing hydrophilicity. Thereafter, the protective film is removed, and thus the desired wall surface is allowed to be hydrophilic.

In order to allow the wall surface of the channel portion 102a provided in the hydrophilic substrate main body 110 to be hydrophobic, the entire substrate is subjected to a treatment for providing hydrophobicity by heating the entire substrate main body at 200 to 300° C. under reduced pressure for 1 to 3 hours. Then, the wall surface desired to be hydrophobic of the wall surface of the groove portion 123 is covered with a protective film, and then the wall surface excluding the desired wall surface is subjected to a treatment for providing hydrophilicity. Thereafter, the protective film is removed, and thus the desired wall surface is allowed to be hydrophobic.

Although it is necessary to perform a treatment for heating the entire substrate main body when the substrate main body 110 is made of a metal oxide based ceramic material such as aluminum oxide, the heating treatment is not necessary when the substrate main body 110 is made of other ceramic materials. For example, when the substrate main body 110 is made of a nitride based ceramic material such as silicon nitride or carbon nitride, the surface of the substrate main body 110 is already hydrophobic when fired, and therefore there is no need of further performing a heating treatment.

However, after the substrate main body 110 is formed by sintering ceramic green sheets, it is necessary to perform plating of a portion to be connected electrically to the outside, for example, a power supply terminal for driving a pump. In this case, various treatments are performed, so that the state of the surface of the substrate main body 110 is changed. Therefore, in this case, it is necessary to allow the substrate main body 110 to be hydrophobic by heating the entire substrate main body 110.

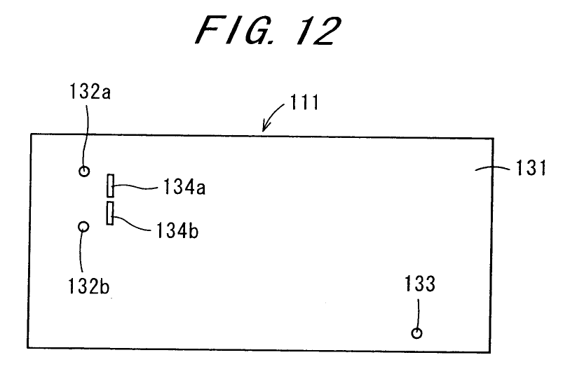

FIG. 12 is a plan view showing a simplified structure of the lid 111. As shown in FIG. 12, the through-holes 132a, 132b and 133 that are in communication with the groove portion 123 of ceramic green sheet 121 shown in FIG. 10A are formed in the predetermined positions that are to serve as the supply ports 56a and 56b and the collection portion 55 in the substrate 131 made of, for example, glass or a ceramic material, and thus the lid 111 can be obtained.

The lid 111 is bonded onto the surface on which the groove portions 123 and 124 are exposed of the substrate main body 110. For example, the lid 111 and the substrate main body 110 are bonded by heating and pressing when the lid 111 is made of glass, and are bonded with a glass adhesive when the lid 111 is made of a ceramic material.

Next, piezoelectric materials 134a and 134b such as lead zirconate titanate (PZT; composition formula: Pb(Zr, Ti)O₃) are attached into predetermined positions on the surface of the lid 111, and conduction lines (not shown) for applying a voltage to the piezoelectric materials 134a and 134b are formed. The piezoelectric materials 134a and 134b can vibrate the lid 111 above the supply channels 57a and 57b by expanding or contracting in accordance with the applied voltage, and therefore the micropumps 58a and 58b for delivering fluids can be formed by attaching the piezoelectric materials 134a and 134b to the lid 111 above the supply channels 57a and 57b.

In the manner described above, the substrate 101 shown in FIGS. 9A and 9B is formed so that the microchemical chip 91 can be obtained. Thus, the lid 111 and the substrate main body 110 in which the wall surface of the groove portion 123 that is to serve as the channel portion 102a on the downstream side from the junction portion 112 between the channel 102 and the supply portions 53a and 53b is hydrophilic or hydrophobic are attached, so that the microchemical chip 91 provided with the channel 102 having the hydrophilic portion 102a having the hydrophilic wall surface (or the hydrophobic portion 102a having the hydrophobic wall surface) on the downstream side in the flowing direction of the fluid to be treated from the position 112 where the supply portions 53a and 53b are connected to the channel 102 can be obtained.

In this embodiment, the substrate main body 110 is formed by laminating the ceramic green sheets 121 in which the groove portion 123 is formed by pressing of a pattern and the ceramic green sheet 122 in which the conduction line pattern 124 that is to serve as the heater 59 is formed, and sintering the laminate. Then, the treatment for providing hydrophilicity or hydrophobicity is performed, and then the groove portion 123 on the surface of the substrate main body 110 is covered with the lid 111, and thus the substrate 101 having the channel 102 can be formed. Therefore, the microchemical chip 91 can be produced only by simple processing without performing complicated processing such as etching processing that is necessary when forming a channel in a substrate made of silicon, glass or resin.

As described above, although the microchemical chip 91 of this embodiment has two supply portions 53a and 53b, the invention is not limited thereto, and the microchemical chip 91 can have three or more supply portions. When two or more supply portions are provided, it is not necessary that the supply channels of the supply portions are merged in one portion, but the supply channels can be connected to the channel 102 at different positions. In this case, it is preferable that the channel 102 has a hydrophilic portion having a hydrophilic wall surface or a hydrophobic portion having a hydrophobic wall surface on the downstream side in the flowing direction of the fluid to be treated from the positions in which each of the supply portions is connected to the channel 102.

In particular, when a hydrophobic fluid to be treated is poured from one supply portion and a hydrophilic fluid to be treated is poured from another supply portion, it is preferable to provide the hydrophilic portion on the downstream side in the flowing direction of the fluid to be treated from the position where the supply portion from which the hydrophobic fluid is pored is connected to the channel 102, and to provide the hydrophobic portion on the downstream side in the flowing direction of the fluid to be treated from the position where the supply portion from which the hydrophilic fluid is pored is connected to the channel 102. Thus, when both the hydrophilic portion and the hydrophobic portion are provided in the channel 102, for example, the portion excluding the wall surface desired to be hydrophilic of the groove portion 123 in the substrate main body 110 shown in FIG. 3 is covered with a protective film, and then the a treatment for providing hydrophilicity is performed to the desired wall surface. Thereafter, the protective film is removed. Then, the portion excluding the wall surface desired to be hydrophobic is covered with a protective film, and then a treatment for providing hydrophobicity is performed to the desired wall surface. Thereafter, the protective film is removed. Thus, both the hydrophilic portion and the hydrophobic portion can be formed distinctly in the channel 102.

Although the hydrophilic portion having the hydrophilic wall surface (or the hydrophobic portion) 102a is shown so as to be provided in the linear portion of the channel 102 in the drawing, the invention is not limited thereto. It is possible to provide a curved portion in the channel 102, and provide the hydrophilic portion (or the hydrophobic portion) 102a in this portion. In this case, the curved portion and the hydrophilic portion (or the hydrophobic portion) 102a can generate a more effective turbulent flow, so that the fluids to be treated can be mixed sufficiently.

In the microchemical chip 91 of this embodiment, the collection portion 55 is provided and a reaction product is drawn from the collection portion 55. However, when a detecting portion is provided in the collection portion 55 or on the upstream side in the flowing direction of the fluid to be treated from the collection portion 55, a reaction product of a chemical reaction or a biochemical reaction such as an antigen-antibody reaction and an enzyme reaction can be detected. In this case, it is preferable to configure the hydrophilic or hydrophobic wall surface in a channel portion on the upstream side in the flowing direction of the fluid to be treated from the detecting portion.

In the method for producing the microchemical chip 91 of this embodiment, the substrate main body 110 is formed with two ceramic green sheets, that is, the ceramic green sheet 121 in which the groove portion 123 is formed and the ceramic green sheet 122 in which the wiring pattern 124 that is to serve as the heater 59 is formed. However, the invention is not limited thereto, and the substrate main body 110 can be formed with three or more ceramic green sheets.

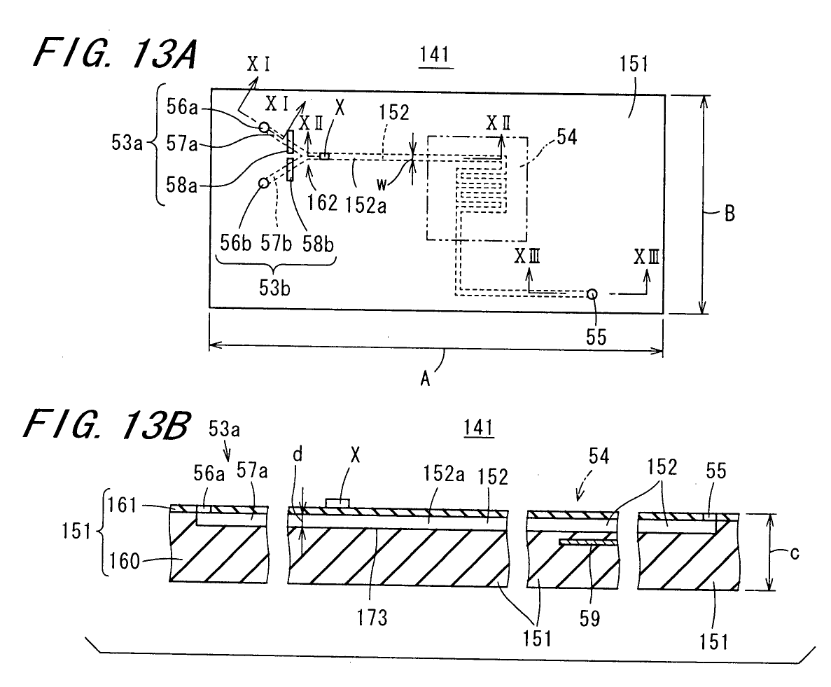

FIG. 13A is a plan view showing a simplified structure of a microchemical chip 141 of a fourth embodiment of the invention. FIG. 13B is cross-sectional views showing cross-sectional structures taken along sectional lines XI-XI, XII-XII, and XIII-XIII of the microchemical chip 141 shown in FIG. 13A. In FIG. 13B, the cross-sectional structures taken along the sectional lines XI-XI, XII-XII and XIII-XIII are shown in this order. In this embodiment, the same components as those of the aforementioned embodiment will be denoted by the same reference numerals, and it will be omitted to describe in detail.

The microchemical chip 141 has a substrate 151 provided with a channel 152 through which a fluid to be treated flows, two supply portions 53a and 53b from each of which the fluid to be treated is poured into the channel 152, a treatment portion 54, and a collection portion 55 from which the treated fluid is drawn to the outside. The substrate 151 includes a substrate main body 160, on one surface of which groove portions are formed, and a lid 161 that is a covering portion, and the channel 152 is formed by covering the surface of the substrate main body 160 provided with the groove portions 173 with the lid 161.

In this microchemical chip 141, a vibrating element X is provided in the vicinity of a position 162 where the channel 152 and the supply portions 53a and 53b are connected. In this embodiment, the vibrating element is provided in the lid 161 at a position corresponding to the inner surface of a channel portion in the vicinity of the position where the supply portions 53a and 53b and the channel 152 are connected on the downstream side in the flowing direction of a fluid to be treated from that position.

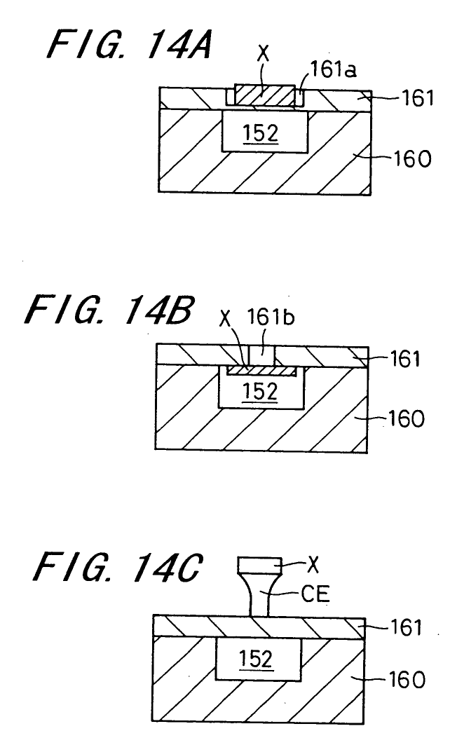

FIGS. 14A to 14C are cross-sectional views showing the arrangement including the vibrating element X. FIG. 14A is a cross-sectional view showing the arrangement when a piezoelectric element made of lead zirconate titanate (PZT; composition formula: Pb(Zr, Ti)O₃) or the like is used as the vibrating element X. On the outer surface of the lid 161, a recess portion 161a is formed at a position opposed to the inner surface of a portion of the channel 152 in the vicinity of the position where the channel 152 and the supply portions 53a and 53b are connected on the downstream side in the flowing direction of a fluid to be treated from that position. The vibrating element X is provided inside the recess portion 161a. The power for driving the vibrating element X is supplied through a conduction line formed on the outer surface of the lid 161. Connection between the conduction line and the vibrating element X is established by, for example, wire bonding.

The vibration of the vibrating element X vibrates the portion where the vibrating element X is provided in the lid 161, and this vibration is transmitted to the fluid to be treated flowing through the channel 152. Thus, a turbulent flow is generated in the merged fluids to be treated so that the plurality of fluids to be treated that are merged can be mixed. The vibrating element X is provided in the recess portion 161a formed in the lid 161. This means that the vibrating element X is provided in a portion having a smaller thickness than that of the surrounding portion. Therefore the portion in which the vibrating element X is provided can be vibrated more reliably, and thus the merged fluids to be treated can be mixed more efficiently.

FIG. 14B is a cross-sectional view showing the arrangement when a crystal vibrator is used as the vibrating element X. In the lid 161, a through-hole 161b that is a long pore along the flowing direction (direction perpendicular to the sheet of FIG. 14B) of the channel 152 is formed at a position on the inner surface of a channel portion in the vicinity of the position where the channel 152 and the supply portions 53a and 53b are connected on the downstream side in the flowing direction of a fluid to be treated from that position. The vibrating element X is attached to the inner surface of the lid 161 such that the through-hole 161b is covered. The power for driving the vibrating element X is supplied through a conduction line formed from the outer surface of the lid 161 along the inner surface of the through-hole 161b and connected to the vibrating element X. The vibration from the vibrating element X is transmitted directly to the fluid to be treated flowing through the channel 152.

FIG. 14C is a cross-sectional view showing the arrangement when an ultrasonic vibrator is used as the vibrating element X. The ultrasonic vibrator is attached to an end portion having a larger diameter of a cone CE (cylindrical member whose outer shape is approximately conical). An end portion having a smaller diameter of the cone CE provided with the ultrasonic vibrator is attached onto the outer surface of the lid 161 at a position opposed to the inner surface of a channel portion in the vicinity of the position where the channel 152 and the supply portions 53a and 53b are connected on the downstream side in the flowing direction of a fluid to be treated from that position. In this manner, the ultrasonic vibrator is attached to the lid 161. The power for driving the ultrasonic vibrator is supplied through a conduction line formed on the outer surface of the lid 161 and connected to the ultrasonic vibrator. The vibration from the ultrasonic vibrator is transmitted to the fluid to be treated flowing through the channel 152 via the cone CE and the lid 161.

A heater 59 is provided inside the substrate main body 160 below the channel 152 in the treatment portion 54.

In the microchemical chip 141, two fluids to be treated are poured from the two supply portions 53a and 53b to the channel 152 and are merged into one, and the channel 152 is heated at a predetermined temperature with a heater 59 in the treatment portion 54, if necessary, so that the two poured fluids to be treated are reacted, and then the obtained reaction product is drawn from the collection portion 55.

The cross-section area of the channel 152 and the supply channels 57a and 57b is preferably 2.5×10⁻³ mm² or more and 1 mm² or less in order to efficiently deliver and mix specimens, reagents, or cleaning liquids poured from the supply portions 53a and 53b. However, the fluid flowing through the channel having a cross-section area of about 2.5×10⁻³ mm² to 1 mm² generally flows in a state of a laminar flow, so that simply connecting the two supply channels 57a and 57b allows the two fluids that are poured into the channel 152 from the supply portions 53a and 53b and merged to be mixed only by diffusion. Therefore, it is necessary to provide a long channel in order to mix the merged two fluids fully, which limits the achievement of a compact microchemical chip.

On the other hand, in this embodiment, the vibrating element X is provided on the downstream side in the flowing direction of a fluid to be treated from the position 162 where the channel 152 and the supply portions 53a and 53b are connected, and therefore when a plurality of fluids to be treated are merged and vibration from the vibrating element X is applied thereto, then a turbulent flow is generated in the merged fluids to be treated.

Thus, the plurality of fluids to be treated can be mixed by generating a turbulent flow in the merged fluids to be treated. Consequently, compared with the case where fluids are mixed only by diffusion, the plurality of fluids to be treated can be mixed sufficiently in a short channel. Therefore, since the length of the channel 152 can be reduced, the size of the microchemical chip 141 can be reduced, and the size of a microchemical system using the microchemical chip 141 can be reduced. Furthermore, since a predetermined treatment is performed in a state where the plurality of fluids to be treated are mixed sufficiently, the predetermined treatment can be performed more reliably in comparison with the case where mixture is not adequate.

In this embodiment, the vibrating element X is provided between the junction position 162 and the treatment portion 54, so that the merged fluids to be treated are mixed sufficiently when the fluids have reached the treatment portion 54. Therefore, for example, when pouring a compound that is a raw material from the supply portion 53a, pouring a reagent from the supply portion 53b, merging the compound and the reagent and heating the merged compound and reagent with the heater 59 in the treatment portion 54 to cause a reaction, the compound and the reagent can be heated with being mixed sufficiently. Consequently, the compound and the reagent can be reacted efficiently and the yield of a reaction product that can be collected from the collection portion 55 can be improved.

As the substrate main body 160, like the substrate main body 60 and 110 of the above-mentioned embodiments, a substrate made of a ceramic material, silicon, glass or resin can be used, and among these, it is preferable to use a substrate made of a ceramic material.

The lid 161 can be formed of glass or a ceramic material, but it is preferable to use glass for the lid 161 because the mixture state or the reaction state of the fluid to be treated can be confirmed.

For the same reason as those of the above-mentioned embodiments, the cross-section area of the channel 152 and the supply channels 57a and 57b is preferably 2.5×10⁻³ mm² or more and 1 mm² or less in order to efficiently deliver and mix specimens, reagents, or cleaning liquids poured from the supply portions 53a and 53b.

Like the above-mentioned embodiments, the width w of the channel 152 and the supply channels 57a and 57b is preferably 50 to 1000 μm, more preferably 100 to 500 μm. Like the above-mentioned embodiments, the depth d of the channel 152 and the supply channels 57a and 57b is preferably 50 to 1000 μm, more preferably 100 to 500 μm, and within the preferable range of the cross-section area as described above. In the case that the cross-section shape of the channel 152 and the supply channels 57a and 57b is rectangle, like the above-mentioned embodiments, the relationship between the width and the depth is preferably the length of the shorter side/the length of the longer side ≧0.4, more preferably the length of the shorter side/the length of the longer side ≧0.6. When the length of the shorter side/the length of the longer side <0.4, the pressure loss is large, which causes a problem in delivering fluids.

Like the above-mentioned embodiments, the outline size of the microchemical chip 141 is, for example, such that the width A is about 40 mm, the depth B is about 70 mm, and the height C is about 1 to 2 mm, but the invention is not limited thereto, and an appropriate outline size can be used, depending on the necessity.

The microchemical chip 141 after use can be used again when the microchemical chip 141 is cleaned by pouring a cleaning liquid from the supply portions 53a and 53b.

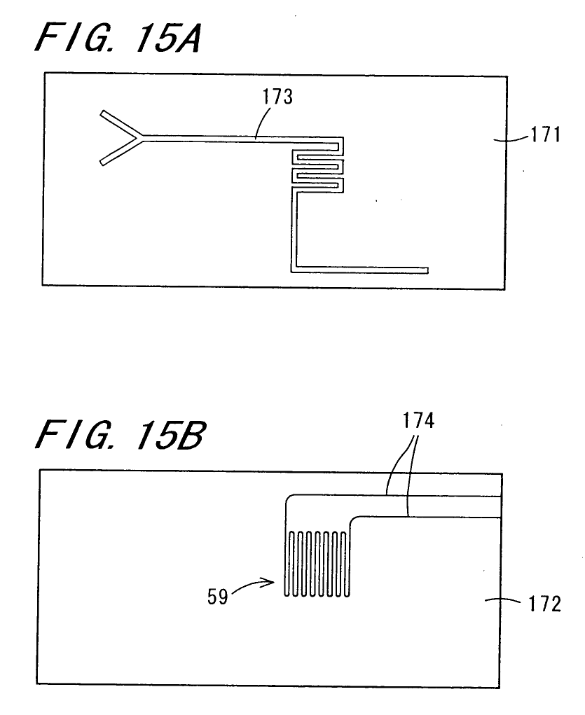

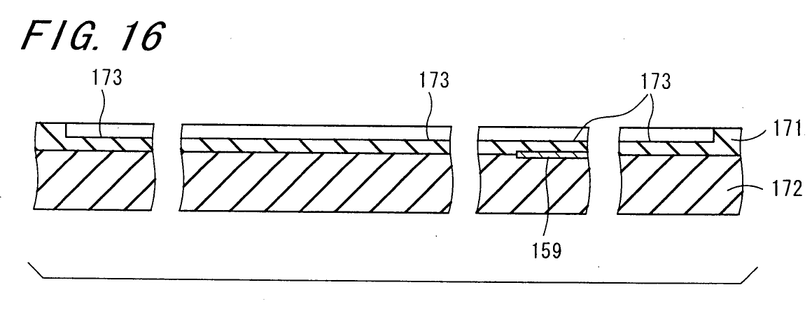

Next, a method for producing the microchemical chip 141 shown in FIGS. 13A and 13B will be described. In this embodiment, the case where the substrate main body 160 is made of a ceramic material will be described. FIGS. 15A and 15B are plan views showing the states of the processed ceramic green sheets 171 and 172. FIG. 16 is a cross-sectional view showing the state in which the ceramic green sheets 171 and 172 are laminated.

First, a suitable organic binder and solvent are mixed with a raw material powder, and if necessary, a plasticizer or a dispersant is added thereto, and the mixture is formed into a slurry. Then, the slurry is molded into a sheet by doctor blading, calendar rolling or the like. Thus, a ceramic green sheet (also referred to as “ceramic crude sheet”) is formed. As the raw material powder, for example, when the substrate 160 is made of an aluminum oxide sintered substance, aluminum oxide, silicon oxide, magnesium oxide, and calcium oxide or the like can be used.

In this embodiment, two of the thus formed ceramic green sheets are used to form the substrate main body 160. First, as shown in FIG. 15A, a groove portion 173 is formed by pressing the surface of the ceramic green sheet 171 with a pattern. In this case, a pattern having a shape to which desired shapes of the groove portions 173 is transferred is used.

The pressing pressure for pressing the slurry with the pattern is adjusted depending on the viscosity of the slurry before being molded into the ceramic green sheet. For example, when the viscosity of the slurry is 1 to 4 Pa·s, a pressure of 2.5 to 7 MPa is applied to the slurry. There is no particular limitation regarding the material of the pattern, and a metal pattern or a wooden pattern can be used.

Next, as shown in FIG. 15B, the heater 59 and a wiring pattern 174 for external power connection are formed on the surface of the ceramic green sheet 172 by applying a conductive paste in a predetermined shape by screen printing or the like. The conductive paste can be obtained by mixing a metal material powder such as tungsten, molybdenum, manganese, copper, silver, nickel, palladium, or gold with a suitable organic binder and solvent. For the conductive paste for forming the wiring pattern 174 that is to serve as the heater 59, a conductive paste in which 5 to 30 wt % of a ceramic powder is added to a metal material powder as described above such that a predetermined resistivity is achieved after firing is used.

As shown in FIG. 16, the ceramic green sheet 171 provided with the groove portion 173 is laminated on the surface of the ceramic green sheet 172 provided with the wiring pattern 174 that is to serve as the heater 59. The laminated ceramic green sheets 171 and 172 are sintered at a temperature of about 1600° C. Thus, the substrate main body 160 provided with the groove portion 173 that is to serve as the channel 152, which is shown in FIGS. 13A and 13B, can be formed.

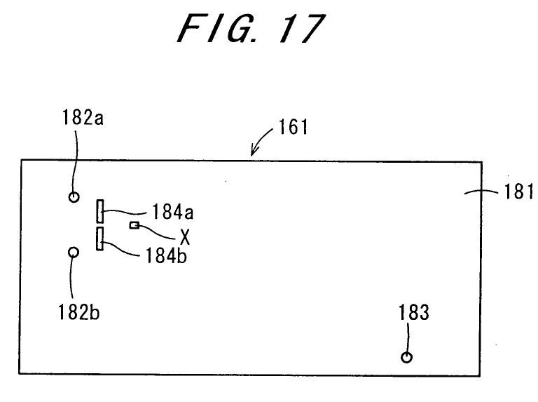

FIG. 17 is a plan view showing a simplified structure of the lid 161. As shown in FIG. 17, the through-holes 182a, 182b and 183 that are in communication with the groove portion 33 of ceramic green sheet 171 shown in FIG. 15A are formed in the predetermined positions that are to serve as the supply ports 56a and 56b and the collection portion 55 in the substrate 181 made of, for example, glass or a ceramic material. Furthermore, on the outer surface of the substrate 181, a recess 161a is formed at a position corresponding to the inner surface of a channel portion in the vicinity of the position where the channel 152 and the supply portions 53a and 53b are connected on the downstream side in the flowing direction of a fluid to be treated from that position. The vibrating element X is provided inside the recess portion 161a. Furthermore, on the outer surface of the substrate 161, a conduction line (not shown) via which the power for driving the vibrating element X is supplied is formed, and this conduction line and the vibrating element X are connected by, for example, wire bonding. Thus, the lid 161 can be obtained.

The lid 161 is bonded onto the surface on which the groove portion 173 is exposed of the substrate main body 160. For example, the lid 161 and the substrate main body 160 are bonded by heating and pressing when the lid 161 is made of glass, and are bonded with a glass adhesive when the lid 161 is made of a ceramic material.

Next, piezoelectric materials 184a and 184b such as lead zirconate titanate (PZT; composition formula: Pb(Zr, Ti)O₃) are attached into predetermined positions on the surface of the lid 161, and conduction lines (not shown) for applying a voltage to the piezoelectric materials 184a and 184b are formed. The piezoelectric materials 184a and 184b can vibrate the lid 161 above the supply channels 57a and 57b by expanding or contracting in accordance with the applied voltage, and therefore micropumps 58a and 58b for delivering fluids can be formed by attaching the piezoelectric materials 184a and 184b to the lid 161 above the supply channels 57a and 57b.

As described above, the microchemical chip 141 can be obtained by forming the substrate 151 shown in FIGS. 13A and 13B. In this manner, the microchemical chip 141 in which the vibrating element X is provided in the vicinity of the junction position 162 between the channel 152 and the supply portions 53a and 53b, more specifically, on the downstream side in the flowing direction of a fluid to be treated from the junction position 162 can be produced.

In this embodiment, the substrate main body 160 is formed by laminating the ceramic green sheets 171 in which the groove portion 173 is formed by pressing of a pattern and the ceramic green sheet 172 in which the conduction line pattern 174 that is to serve as the heater 59 is formed, and sintering the laminate. Then, the groove portion 173 on the surface of the substrate main body 160 is covered with the lid 161, and thus the substrate 151 having the channel 152 can be formed. Therefore, the microchemical chip 141 can be produced only by simple processing without performing complicated processing such as etching processing that is necessary when forming a channel in a substrate made of silicon, glass or resin.

As described above, although the microchemical chip 141 of this embodiment has two supply portions 53a and 53b, the invention is not limited thereto, and the microchemical chip 141 can have three or more supply portions. When two or more supply portions are provided, it is not necessary that the supply channels of the supply portions are merged in one portion, but the supply channels can be connected to the channel 152 at different positions. In this case, it is preferable to provide the vibrating element X in the vicinity of the positions where the channel 152 and each of the supply portions are connected.

In the microchemical chip 141 of this embodiment, the collection portion 55 is provided and a reaction product is drawn from the collection portion 55. However, when a detecting portion is provided in the collection portion 55 or on the upstream side in the flowing direction of the fluid to be treated from the collection portion 55, a reaction product of a chemical reaction or a biochemical reaction such as an antigen-antibody reaction and an enzyme reaction can be detected. In this case, it is preferable to provide the vibrating element X in a channel portion on the upstream side in the flowing direction of a fluid to be treated from the detecting portion.

In the method for producing the microchemical chip 141 of this embodiment, the substrate main body 160 is formed with two ceramic green sheets, that is, the ceramic green sheet 171 in which the groove portion 173 is formed and the ceramic green sheet 172 in which the wiring pattern 174 that is to serve as the heater 59 is formed. However, the invention is not limited thereto, and the substrate main body 160 can be formed with three or more ceramic green sheets.

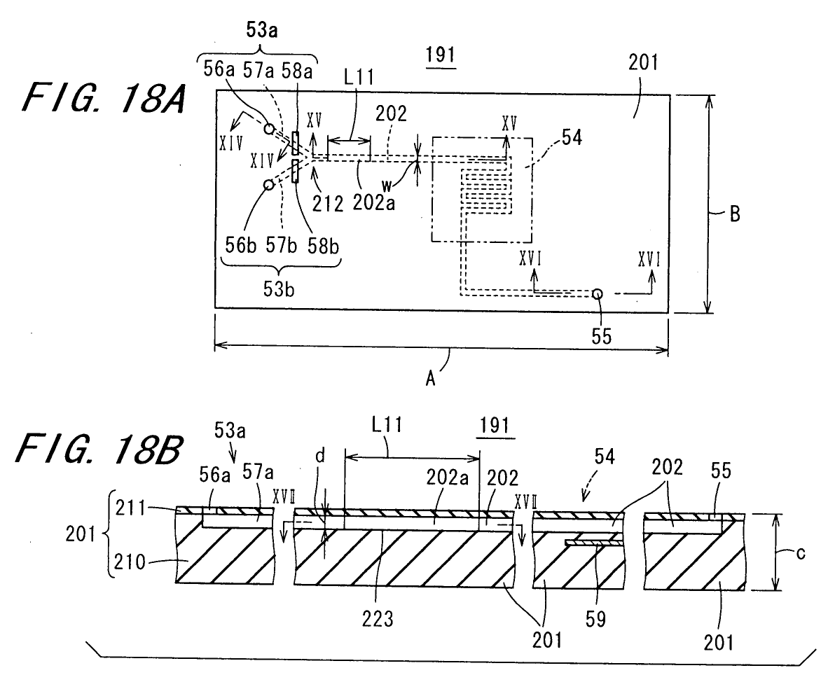

FIG. 18A is a plan view showing a simplified structure of a microchemical chip 191 of a fifth embodiment of the invention. FIG. 18B is cross-sectional views showing cross-sectional structures taken along sectional lines XIV-XIV, XV-XV, and XVI-XVI of the microchemical chip 191 shown in FIG. 18A. In FIG. 18B, the cross-sectional structures taken along the sectional lines XIV-XIV, XV-XV and XVI-XVI are shown in this order. In this embodiment, the same components as those of the aforementioned embodiment will be denoted by the same reference numerals, and it will be omitted to describe in detail.

The microchemical chip 191 has a substrate 201 provided with a channel 202 through which a fluid to be treated flows, two supply portions 53a and 53b from each of which the fluid to be treated is poured into the channel 202, a treatment portion 54, and a collection portion 55 from which the treated fluid is drawn to the outside. The substrate 201 includes a substrate main body 210, on one surface of which groove portions are formed, and a lid 211 that is a covering portion, and the channel 202 is formed by covering the surface of the substrate main body 210 provided with the groove portions with the lid 211.

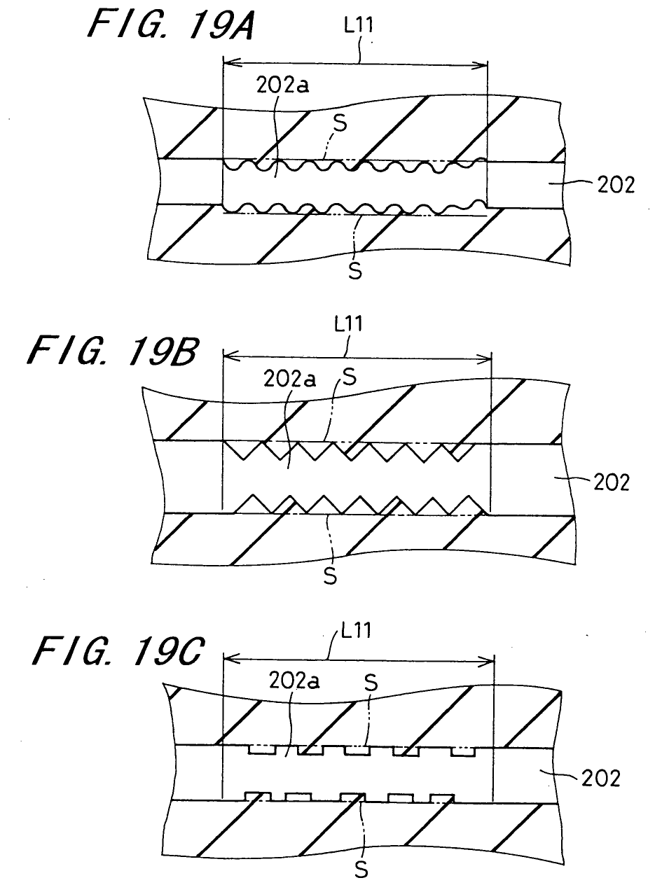

In this microchemical chip 191, the channel 202 has an uneven portion 202a with a length L1 having an uneven wall surface on the downstream side in the flowing direction of a fluid to be treated from the position channel 212 where the supply portions 53a and 53b are connected thereto. FIGS. 19A to 19C are cross-sectional views showing the unevenness of the wall surface of the uneven portion 202a taken along XVII-XVII of FIG. 18B.

The unevenness on the wall surface is formed on each of two opposite side wall faces of the uneven portion 202a. The unevenness is configured, for example, by forming a plurality of protrusions that are projected from a predetermined reference surface S. As the predetermined reference surface S, for example, an extended plane of the side wall face of the channel before and after the uneven portion 202a or a plane parallel to the side wall face thereof can be selected. There is no limitation regarding the shape of the unevenness, but it is preferable that the unevenness is irregular in order to generate a turbulent flow in the fluid to be treated, and more specifically, a shape in which a variation in the distance between the wall surfaces in the uneven portion 202a is generated is preferable. If the unevenness is defined by the surface roughness, an arithmetical mean roughness (Ra) of 2.0 to 10.0 μm is preferable.

For example, as shown in FIG. 19A, a plurality of protrusions having an approximately semicircular pillar shape may be formed, and smoothly curved unevenness in which the recess portions between the protrusions are formed with the same curve as that in the protrusions may be formed. In this case, by providing different gaps in the arrangement of approximately semicircular pillar-shaped protrusions or by displacing the arrangement positions of the approximately semicircular pillar-shaped protrusions relative to the opposing protrusions on the side wall face, unevenness in which a variation in the distance between the side wall faces in the uneven portion 202a is generated can be realized.

As shown in FIG. 19B, unevenness of a zigzag polygonal line formed with a plurality of protrusions having an approximately triangular prism may be formed. In this case, by displacing the arrangement positions of the approximately triangular prism-shaped protrusions relative to the opposing protrusions on the side wall face, unevenness in which a variation in the distance between the side wall faces in the uneven portion 202a is generated can be realized.

As shown in FIG. 19C, unevenness formed with a plurality of protrusions having an approximately quadratic pillar shape may be formed. In this case, by providing different gaps in the arrangement of approximately quadratic prism-shaped protrusions or by displacing the arrangement positions of the approximately quadratic prism-shaped protrusions relative to the opposing protrusions on the side wall face, unevenness in which a variation in the distance between the side wall faces in the uneven portion 202a is generated can be realized.

It is sufficient that the unevenness in the uneven portion 202a is formed in at least one portion of the surface in which the channel is formed. For example, in the case where the channel 202 is formed with four faces as in this embodiment, unevenness may be formed on at least one face of the four faces, that is, the bottom face, the top face and the two opposing side wall faces. Furthermore, for example, unevenness may be formed on three faces, that is, the bottom face and the two opposing side wall faces, of the four faces, or unevenness may be formed on all the four faces, that is, the bottom face, the top face and the two opposing side wall faces.

The unevenness of the uneven portion 202a is not limited to a protrusion of a pillar shape such as an approximately semicircular pillar shape but can be a projection. The projection can be, for example, conical, pyramid-shaped, pillar-shaped or the like. The width or the depth in a given portion in the uneven portion 202a, such as the central portion, can be increased. In this case, a plurality of fluids to be treated can be mixed sufficiently in a portion having a large width or a large depth. Such a portion having a large width or a large depth can be provided in a plurality of points in a given portion in the uneven portion 202a. Furthermore, a pond-shaped portion can be provided in a given portion in the uneven portion 202a, such as the central portion. Also in this case, a plurality of fluids to be treated can be mixed sufficiently in the pond-shaped portion.

A heater 59 is provided inside the substrate main body 210 below the channel 202 in the treatment portion 54.

In the microchemical chip 191, two fluids to be treated are poured from the two supply portions 53a and 53b to the channel 202 and are merged into one, and the channel 202 is heated at a predetermined temperature with a heater 59 in the treatment portion 54, if necessary, so that the two poured fluids to be treated are reacted, and then the obtained reaction product is drawn from the collection portion 55.

The cross-section area of the channel 202 and the supply channels 57a and 57b is preferably 2.5×10⁻³ mm² or more and 1 mm² or less in order to efficiently deliver and mix specimens, reagents, or cleaning liquids poured from the supply portions 53a and 53b. However, the fluid flowing through the channel having a cross-section area of about 2.5×10⁻³ mm² to 1 mm² generally flows in a state of a laminar flow, so that simply connecting the two supply channels 57a and 57b allows the two fluids that are poured into the channel 202 from the supply portions 53a and 53b and merged to be mixed only by diffusion. Therefore, it is necessary to provide a long channel in order to mix the merged two fluids fully, which limits the achievement of a compact microchemical chip.

On the other hand, in this embodiment, the channel 202 has the uneven portion 202a with a length L1 having the uneven wall surface on the downstream side in the flowing direction of the fluid to be treated from the junction portion 212 between the channel 202 and the supply portions 53a and 53b, so that when a plurality of fluids to be treated are merged and pass through the uneven portion 202a, a turbulent flow is generated in the merged fluids to be treated.

Thus, a plurality of fluids to be treated can be mixed by generating a turbulent flow in the merged fluids to be treated. Consequently, compared with the case where fluids are mixed only by diffusion, a plurality of fluids to be treated can be mixed sufficiently in a short channel. Therefore, since the length of the channel 202 can be reduced, the size of the microchemical chip 191 can be reduced, and the size of a microchemical system using the microchemical chip 191 can be reduced. Furthermore, since a predetermined treatment is performed in a state where a plurality of fluids to be treated are mixed sufficiently, the predetermined treatment can be performed more reliably than in the case where mixture is not adequate.

In this embodiment, the channel 202 has the uneven portion 202a between the junction position 212 and the treatment portion 54, so that the merged fluids to be treated are mixed sufficiently when the fluids have reached the treatment portion 54. Therefore, for example, when pouring a compound that is a raw material from the supply portion 53a, pouring a reagent from the supply portion 53b, merging the compound and the reagent and heating the merged compound and reagent with the heater 59 in the treatment portion 54 to cause a reaction, the compound and the reagent can be heated with being mixed sufficiently. Consequently, the compound and the reagent can be reacted efficiently and the yield of a reaction product that can be collected from the collection portion 55 can be improved.

As the substrate main body 210, like the substrate main body 60, 110 and 160 of the above-mentioned embodiments, a substrate made of a ceramic material, silicon, glass or resin can be used, and among these, it is preferable to use a substrate made of a ceramic material.

The lid 211 can be formed of glass or a ceramic material, but it is preferable to use glass for the lid 211 because the mixture state or the reaction state of the fluid to be treated can be confirmed.

For the same reason as those of the above-mentioned embodiments, the cross-section area of the channel 202 and the supply channels 57a and 57b is preferably 2.5×10⁻³ mm² or more and 1 mm² or less in order to efficiently deliver and mix specimens, reagents, or cleaning liquids poured from the supply portions 53a and 53b.

Like the above-mentioned embodiments, the width w of the channel 202 and the supply channels 57a and 57b is preferably 50 to 1000 μm, more preferably 100 to 500 μm. Like the above-mentioned embodiments, the depth d of the channel 202 and the supply channels 57a and 57b is preferably 50 to 1000 μm, more preferably 100 to 500 μm, and within the preferable range of the cross-section area as described above. In the case that the cross-section shape of the channel 202 and the supply channels 57a and 57b is rectangle, like the above-mentioned embodiments, the relationship between the width (longer side) and the depth (shorter side) is preferably the length of the shorter side/the length of the longer side ≧0.4, more preferably the length of the shorter side/the length of the longer side ≧0.6. When the length of the shorter side/the length of the longer side <0.4, the pressure loss is large, which causes a problem in delivering fluids.

Like the above-mentioned embodiments, the outline size of the microchemical chip 191 is, for example, such that the width A is about 40 mm, the depth B is about 70 mm, and the height C is about 1 to 2 mm, but the invention is not limited thereto, and an appropriate outline size can be used, depending on the necessity.

The microchemical chip 191 after use can be used again when the microchemical chip 191 is cleaned by pouring a cleaning liquid from the supply portions 53a and 53b.

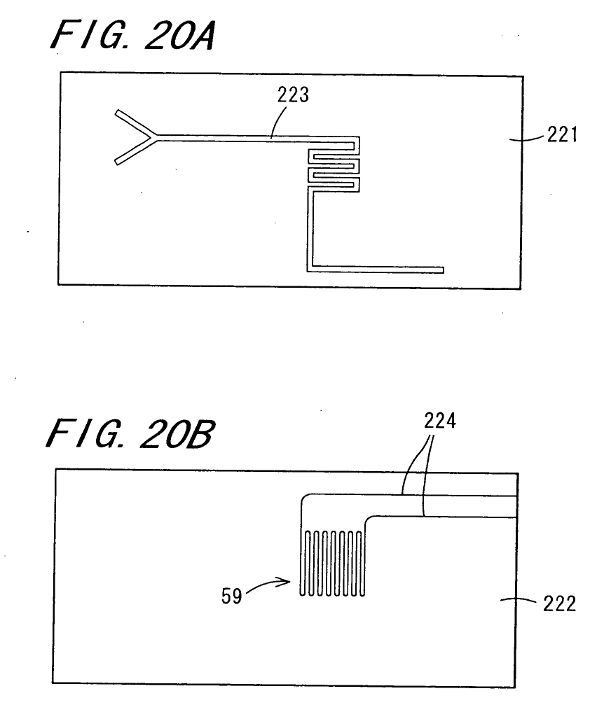

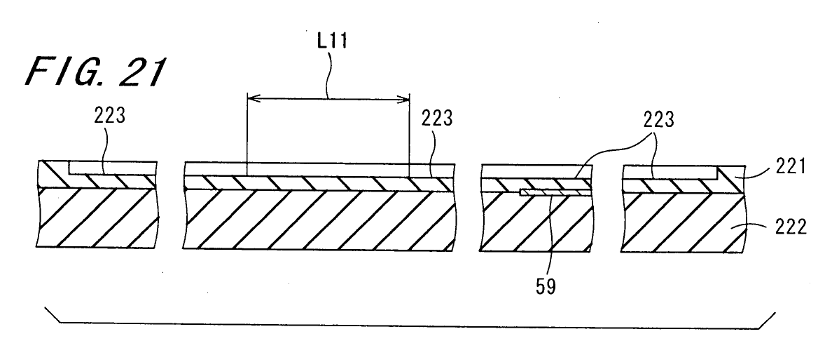

Next, a method for producing the microchemical chip 191 shown in FIGS. 18A and 18B will be described. In this embodiment, the case where the substrate main body 210 is made of a ceramic material will be described. FIGS. 20A and 20B are plan views showing the states of the processed ceramic green sheets 221 and 222. FIG. 21 is a cross-sectional view showing the state in which the ceramic green sheets 221 and 222 are laminated.

First, a suitable organic binder and solvent are mixed with a raw material powder, and if necessary, a plasticizer or a dispersant is added thereto, and the mixture is formed into a slurry. Then, the slurry is molded into a sheet by doctor blading, calendar rolling or the like. Thus, a ceramic green sheet (also referred to as “ceramic crude sheet”) is formed. As the raw material powder, for example, when the substrate main body 210 is made of an aluminum oxide sintered substance, aluminum oxide, silicon oxide, magnesium oxide, and calcium oxide or the like can be used.

In this embodiment, two of the thus formed ceramic green sheets are used to form the substrate main body 210. First, as shown in FIG. 20A, a groove portion 223 is formed by pressing the surface of the ceramic green sheet 221 with a pattern. In this case, a pattern having a shape to which desired shape of the groove portion 223 is transferred is used. Furthermore, in this pattern, as the shape of the groove portion, a predetermined uneven shape is transferred in a portion corresponding to the wall surface of the groove portion constituting the uneven portion 202a. By using a pattern having such a shape, unevenness can be formed on the wall surface of the groove portion constituting the uneven portion 202a.

The pressing pressure for pressing the slurry with the pattern is adjusted depending on the viscosity of the slurry before being molded into the ceramic green sheet. For example, when the viscosity of the slurry is 1 to 4 Pa·s, a pressure of 2.5 to 7 MPa is applied to the slurry. There is no particular limitation regarding the material of the pattern, and a metal pattern or a wooden pattern can be used.

Next, as shown in FIG. 20B, the heater 59 and a wiring pattern 224 for external power connection are formed on the surface of the ceramic green sheet 222 by applying a conductive paste in a predetermined shape by screen printing or the like. The conductive paste can be obtained by mixing a metal material powder such as tungsten, molybdenum, manganese, copper, silver, nickel, palladium, or gold with a suitable organic binder and solvent. For the conductive paste for forming the wiring pattern 224 that is to serve as the heater 59, a conductive paste in which 5 to 30 wt % of a ceramic powder is added to a metal material powder as described above such that a predetermined resistivity is achieved after firing is used.

As shown in FIG. 21, the ceramic green sheet 221 provided with the groove portion 223 is laminated on the surface of the ceramic green sheet 222 provided with the wiring pattern 224 that is to serve as the heater 59. The laminated ceramic green sheets 221 and 222 are sintered at a temperature of about 1600° C. Thus, the substrate main body 210 shown in FIG. 21 in which unevenness is formed on the wall surface of the groove portion 223 that is to serve as the uneven portion 202a on the downstream side from the junction position 212 between the channel 202 and the supply portions 53a and 53b can be formed.

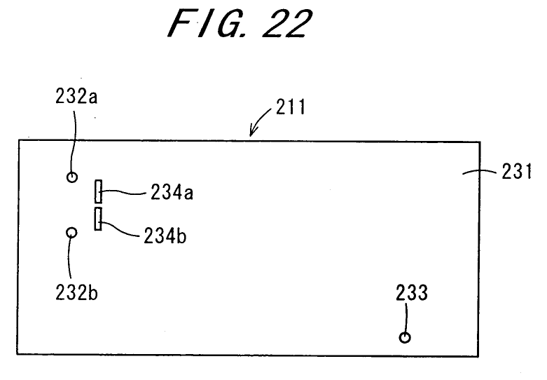

FIG. 22 is a plan view showing a simplified configuration of the lid 211. As shown in FIG. 22, through-holes 232a, 232b and 233 in communication with the groove portion 223 in the ceramic green sheet 221 as shown in FIG. 20A are formed in predetermined positions that are to serve as the supply portions 56a and 56b and the collection portion 55 of the substrate 231 made of, for example, glass or a ceramic material, and thus the lid 211 is obtained.

The lid 211 is bonded onto the surface on which the groove portion 223 is exposed of the substrate main body 210. For example, the lid 211 and the substrate main body 210 are bonded by heating and pressing when the lid 211 is made of glass, and are attached with a glass adhesive when the lid 211 is made of a ceramic material.

Next, piezoelectric materials 234a and 234b such as lead zirconate titanate (PZT; composition formula: Pb(Zr, Ti)O₃) are attached into predetermined positions on the surface of the lid 211, and conduction lines (not shown) for applying a voltage to the piezoelectric materials 234a and 234b are formed. The piezoelectric materials 234a and 234b can vibrate the lid 211 above the supply channels 57a and 57b by expanding or contracting in accordance with the applied voltage, and therefore micropumps 58a and 58b for delivering fluids can be formed by attaching the piezoelectric materials 234a and 234b to the lid 211 above the supply channels 57a and 57b.

In the manner described above, the substrate 211 shown in FIGS. 18A and 18B is formed so that the microchemical chip 191 can be obtained. Thus, the lid 221 and the substrate main body 210 in which the unevenness is formed on the wall surface of the groove portion 223 that is to serve as the uneven portion 202a on the downstream side from the junction portion 212 between the channel 202 and the supply portions 53a and 53b are attached, so that the microchemical chip 191 provided with the channel 202 having the uneven portion 202a on the downstream side in the flowing direction of the fluid to be treated from the position 212 where the supply portions 53a and 53b are connected can be obtained.

In this embodiment, the substrate main body 210 is formed by laminating the ceramic green sheets 221 in which the groove portion 223 is formed by pressing of a pattern and the ceramic green sheet 222 in which the conduction line pattern 224 that is to serve as the heater 59 is formed, and sintering the laminate. Thus, the substrate 201 having the channel 202 can be formed. Therefore, the microchemical chip 191 can be produced only by simple processing without performing complicated processing such as etching processing that is necessary when forming a channel in a substrate made of silicon, glass or resin.

As described above, although the microchemical chip 191 of this embodiment has two supply portions 53a and 53b, the invention is not limited thereto, and the microchemical chip 191 can have three or more supply portions. When two or more supply portions are provided, it is not necessary that the supply channels of the supply portions are merged in one portion, but the supply channels can be connected to the channel 202 at different positions. In this case, it is preferable that the channel 202 has an uneven portion having an uneven wall surface on the downstream side in the flowing direction of the fluid to be treated from the position in which each of the supply portions is connected.

Furthermore, in the microchemical chip 191 of this embodiment, the collection portion 55 is provided, and a reaction product is drawn from the collection portion 55. However, when a detecting portion is provided in the collection portion 55 or on the upstream side in the flowing direction of the fluid to be treated from the collection portion 55, a reaction product of a chemical reaction or a biochemical reaction such as an antigen-antibody reaction and an enzyme reaction can be detected. In this case, it is preferable to form unevenness on the wall surface of a channel portion on the upstream side in the flowing direction of the fluid to be treated from the detecting portion.

The lid 61, 111, 161 and 211 is bonded to the substrate main body 60, 110, 160 and 210, but the present invention is not limited thereto, and the lid 61, 111, 161 and 211 can be provided removably from the substrate main body 60, 110, 160 and 210. For example, a structure where pressure is applied to the entire microchemical chip with a silicon rubber sandwiched by the substrate main body 60, 110, 160 and 210 and the lid 61, 111, 161 and 211 is possible. This structure in which the lid 61, 111, 161 and 211 is removable from the substrate main body 60, 110, 160 and 210 makes cleaning for reuse easy.

In the method for producing the microchemical chip 191 of this embodiment, the substrate main body 210 is formed with two ceramic green sheets, that is, the ceramic green sheet 221 in which the groove portion 223 is formed and the ceramic green sheet 222 in which the wiring pattern 224 that is to serve as the heater 59 is formed. However, the invention is not limited thereto, and the substrate main body 210 can be formed with three or more ceramic green sheets.

In the method for producing microchemical chip 141 and 191 of the fourth and fifth embodiments, the substrate 151 and 201 is formed by sintering the ceramic green sheet 171 and 221 with the groove portion 173 and 223 on its surface exposed to form the substrate main body 160 and 210 and then covering the groove portion 173 and 223 on the surface of the substrate main body 160 and 210 with the lid 161 and 211. However, the invention is not limited thereto. The substrate 151 and 201 can be formed by laminating a ceramic green sheet provided with the same through-hole as in the lid 161 and 211 that is in communication with the groove portion 173 and 223 on the surface of the ceramic green sheet 171 and 221 and sintering the ceramic green sheets. When the substrate 151 and 201 are formed in this manner, it is not necessary to attach the lid 161 and 211 after the substrate main body 160 and 210 is formed, so that the productivity can be improved. In the case where a ceramic material such as PZT as described above is used for the piezoelectric materials 184a and 184b; 234a and 234b constituting the micropumps 58a and 58b, after the ceramic piezoelectric material is attached in a predetermined position in the ceramic green sheet provided with the through-hole in communication with the groove portion 173 and 223, the piezoelectric material can be sintered at the same time.

The microchemical chip of the invention can be used for applications such as tests of viruses, bacteria or humor components in humors such as blood, saliva and urine with a reagent, vital reaction experiments between viruses, bacteria or medical fluid and body cells, reaction experiments between viruses or bacteria and medical fluid, reaction experiments between viruses or bacteria and other viruses or bacteria, blood identification, separation and extraction or decomposition of genes with medical fluid, separation and extraction by precipitation or the like of a chemical substance in a solution, decomposition of a chemical substance in a solution, and mixture of a plurality of medical fluids, and can be used for the purpose of other vital reactions or chemical reactions.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

What is claimed is:

1. A microchemical chip comprising a substrate provided with a channel through which a fluid to be treated flows, in which a predetermined treatment is performed with respect to the fluid to be treated flowing through the channel,
wherein the substrate is made of a ceramic material.

2. The microchemical chip of claim 1, wherein the substrate comprises a supply portion from which a fluid to be treated is poured into the channel, and a collection portion from which the treated fluid is drawn to the outside, and
the fluid to be treated is poured from the supply portion to the channel, and the predetermined treatment is performed to the poured fluid to be treated, and then the treated fluid is drawn from the collection portion to the outside.

3. The microchemical chip of claim 1, wherein the substrate comprises a plurality of supply portions from which a plurality of fluids to be treated are poured into the channel, respectively, and a collection portion from which the treated fluids are drawn to the outside, and
the plurality of fluids to be treated are poured from the plurality of supply portions into the channel, respectively, the plurality of fluids poured are merged and subjected to the predetermined treatment, and then the treated fluids are drawn from the collection portion to the outside.

4. A microchemical chip comprising a substrate provided with a channel through which a fluid to be treated flows and a plurality of supply portions connected to the channel and from which a plurality of fluids to be treated are poured into the channel, respectively, wherein the plurality of fluids to be treated are poured from the plurality of supply portions into the channel, respectively, and the plurality of fluids poured are merged and subjected to a predetermined treatment,
wherein the channel has a turbulent flow generating portion on a downstream side in a flowing direction of the fluid to be treated from a position where the supply portions are connected.

5. The microchemical chip of claim 4, wherein the turbulent flow generating portion is a hydrophilic portion having a hydrophilic wall surface.

6. The microchemical chip of claim 4, wherein the turbulent flow generating portion is a hydrophobic portion having a hydrophobic wall surface.

7. The microchemical chip of claim 4, wherein the turbulent flow generating portion is a bend portion.

8. The microchemical chip of claim 7, wherein the bend portion of the channel is formed by coupling a plurality of channels having a different distance from the substrate surface with a channel extending in a direction perpendicular to the substrate surface.

9. The microchemical chip of claim 4, wherein the turbulent flow generating portion is an uneven portion having an uneven wall surface.

10. The microchemical chip of claim 4, wherein the substrate further comprises a collection portion connected to the channel and from which a treated fluid is drawn to the outside, and
wherein the turbulent flow generating portion is provided on the downstream side in the flowing direction of the fluid to be treated from the position in which the supply portions are connected and on an upstream side in the flowing direction of the fluid to be treated from a position in which the collection portion is connected, and
the plurality of fluids to be treated are poured from the plurality of supply portions into the channel, respectively, and the plurality of fluids poured are merged and subjected to the predetermined treatment, and then the treated fluid is drawn from the collection portion to the outside.

11. The microchemical chip of claim 10, wherein the turbulent flow generating portion is a hydrophilic portion having a hydrophilic wall surface.

12. The microchemical chip of claim 10, wherein the turbulent flow generating portion is a hydrophobic portion having a hydrophobic wall surface.

13. The microchemical chip of claim 10, wherein the turbulent flow generating portion is a bend portion.

14. The microchemical chip of claim 13, wherein the bend portion of the channel is formed by coupling a plurality of channels having a different distance from the substrate surface with a channel extending in a direction perpendicular to the substrate surface.

15. The microchemical chip of claim 10, wherein the turbulent flow generating portion is an uneven portion having an uneven wall surface.

16. The microchemical chip of claim 4, wherein the substrate comprises a treatment portion in which the predetermined treatment is performed to the merged fluids on the downstream side in a flowing direction of the fluid to be treated from the position in which the supply portions are connected to the channel, and
wherein the turbulent flow generating portion is provided on the downstream side in the flowing direction of the fluid to be treated from the position in which the supply portions are connected and on an upstream side in the flowing direction of the fluid to be treated from the treatment portion.

17. The microchemical chip of claim 16, wherein the turbulent flow generating portion is a hydrophilic portion having a hydrophilic wall surface.

18. The microchemical chip of claim 16, wherein the turbulent flow generating portion is a hydrophobic portion having a hydrophobic wall surface.

19. The microchemical chip of claim 16, wherein the turbulent flow generating portion is a bend portion.

20. The microchemical chip of claim 19, wherein the bend portion of the channel is formed by coupling a plurality of channels having a different distance from the substrate surface with a channel extending in a direction perpendicular to the substrate surface.

21. The microchemical chip of claim 16, wherein the turbulent flow generating portion is an uneven portion having an uneven wall surface.

22. A microchemical chip comprising a substrate provided with a channel through which a fluid to be treated flows, and in which a predetermined treatment is performed with respect to the fluid to be treated flowing through the channel,
wherein the channel is formed by covering one surface of a substrate main body, on one surface of which a groove portion is formed, with a covering portion, and at least the substrate main body is made of a ceramic material.

23. The microchemical chip of claim 22, wherein the substrate comprises a supply portion from which a fluid to be treated is poured into the channel, and a collection portion from which the treated fluid is drawn to the outside, and
the fluid to be treated is poured from the supply portion to the channel, the predetermined treatment is performed to the poured fluid to be treated, and then the treated fluid is drawn from the collection portion to the outside.

24. The microchemical chip of claim 22, wherein the substrate comprises a plurality of supply portions from which a plurality of fluids to be treated are poured into the channel, respectively, and a collection portion from which the treated fluids are drawn to the outside, and
the plurality of fluids to be treated are poured from the plurality of supply portions into the channel, respectively, and the plurality of fluids poured are merged and subjected to a predetermined treatment, and then the treated fluids are drawn from the collection portion to the outside.

25. A microchemical chip comprising a substrate provided with a channel through which a fluid to be treated flows and a plurality of supply portions connected to the channel and from which a plurality of fluids to be treated are poured into the channel, respectively, wherein the plurality of fluids to be treated are poured from the plurality of supply portions into the channel, respectively, and the plurality of fluids poured are merged and subjected to a predetermined treatment,
wherein a vibrating element is provided in a vicinity of a position in which the channel is connected to the supply portion.

26. The microchemical chip of claim 25, wherein the substrate comprises a substrate main body in which a groove portion is formed and a covering member provided such that the groove portion is covered, and the channel is formed by covering the groove portion formed in the substrate main body with the covering member, and
the vibrating element is provided in the covering member at a position corresponding to an inner surface of a channel portion in a vicinity of a position in which the supply portions are connected on a downstream side in a flowing direction of a fluid to be treated from that position.

27. The microchemical chip of claim 25, wherein the substrate further comprises a collection portion connected to the channel and from which a treated fluid is drawn to the outside, and
wherein the vibrating element is provided on the downstream side in a flowing direction of the fluid to be treated from a position in which the supply portions are connected and on an upstream side in the flowing direction of the fluid to be treated from a position in which the collection portion is connected, and
the plurality of fluids to be treated are poured from the plurality of supply portions into the channel, respectively, and the plurality of fluids poured are merged and subjected to the predetermined treatment, and then the treated fluid is drawn from the collection portion to the outside.

28. The microchemical chip of claim 26, wherein the substrate comprises a treatment portion in which the predetermined treatment is performed to the merged fluids on the downstream side in the flowing direction of the fluid to be treated from a position in which the supply portions are connected to the channel, and
wherein the vibrating element is provided on the downstream side in the flowing direction of the fluid to be treated from the position in which the supply portions are connected and on an upstream side in the flowing direction of the fluid to be treated from the treatment portion.

29. The microchemical chip of claim 27, wherein the substrate comprises a treatment portion in which the predetermined treatment is performed to the merged fluids on the downstream side in the flowing direction of the fluid to be treated from a position in which the supply portions are connected to the channel, and
wherein the vibrating element is provided on the downstream side in the flowing direction of the fluid to be treated from the position in which the supply portions are connected and on an upstream side in the flowing direction of the fluid to be treated from the treatment portion.

30. A method for producing a microchemical chip including a substrate provided with a channel through which a fluid to be treated flows, and in which a predetermined treatment is performed to the fluid to be treated flowing through the channel, comprising:
forming a groove portion by pressing a surface of a ceramic green sheet with a pattern having a predetermined shape;
laminating another ceramic green sheet on the surface of the ceramic green sheet in which the groove portion is formed in such a manner that the groove portion is covered; and
sintering the laminated ceramic green sheets at a predetermined temperature to form the substrate.

31. The method for producing a microchemical chip of claim 30, wherein, when forming the substrate by sintering a laminate including at least three ceramic green sheets to cure the laminate, the method comprises:
forming groove portions by pressing a surface of each of at least two ceramic green sheets with a pattern having a predetermined shape and forming as appropriate a through-hole for communicating the groove portions formed in the different ceramic green sheets;
laminating another ceramic green sheet on a surface of the ceramic green sheets in which the groove portions are formed in such a manner that the groove portions are covered; and
sintering the laminated ceramic green sheets at a predetermined temperature so as to form the substrate.

32. A method for producing a microchemical chip including a substrate provided with a channel through which a fluid to be treated flows, and in which a predetermined treatment is performed to the fluid to be treated flowing through the channel, comprising:
forming a groove portion by pressing a surface of a ceramic green sheet with a pattern having a predetermined shape;
sintering the ceramic green sheet in which the groove portion is formed at a predetermined temperature to form a substrate main body, and
covering the groove portion on the substrate main body with a covering portion to form the substrate.

33. The method for producing a microchemical chip of claim 32, wherein, when forming the substrate main body by sintering a laminate including a plurality of ceramic green sheets, the method comprises:
forming groove portions by pressing a surface of each of at least two ceramic green sheets with a pattern having a predetermined shape and forming as appropriate a through-hole for communicating the groove portions formed in the different ceramic green sheets;
laminating another ceramic green sheet on the surface of the ceramic green sheets in which the groove portions are formed in such a manner that the groove portions are covered; and
sintering the laminated ceramic green sheets at a predetermined temperature to form the substrate main body.

34. A method for producing a microchemical chip including a substrate in which a channel through which a fluid to be treated flows and a plurality of supply portions connected to the channel and from which a plurality of fluids to be treated are poured into the channel, respectively, are formed, and the channel has a hydrophilic portion having a hydrophilic wall surface on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:
forming a groove portion by pressing a surface of a ceramic green sheet with a pattern having a predetermined shape;
sintering the ceramic green sheet in which the groove portion is formed at a predetermined temperature so as to form a substrate main body;
in the case where the substrate main body is hydrophilic,
covering a wall surface desired to be hydrophilic of the wall surface of the groove portion with a protective film, performing a treatment for providing hydrophobicity to the wall surface excluding the desired wall surface, and removing the protective film, so as to provide hydrophilicity to the desired wall surface, and
in the case where the substrate main body is hydrophobic,
covering portions excluding a wall surface desired to be hydrophilic of the wall surface of the groove portion with a protective film, performing a treatment for providing hydrophilicity to the desired wall surface, and removing the protective film, so as to provide hydrophilicity to the desired wall surface; and
covering the groove portion on a surface of the substrate main body with a covering member so as to form the substrate.

35. A method for producing a microchemical chip including a substrate in which a channel through which a fluid to be treated flows and a plurality of supply portions connected to the channel and from which a plurality of fluids to be treated are poured into the channel, respectively, are formed, and the channel has a hydrophobic portion having a hydrophobic wall surface on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:
forming a groove portion by pressing a surface of a ceramic green sheet with a pattern having a predetermined shape;
sintering the ceramic green sheet in which the groove portion is formed at a predetermined temperature so as to form a substrate main body;
in the case where the substrate main body is hydrophilic,
covering portions excluding a wall surface desired to be hydrophobic of the wall surface of the groove portion with a protective film, performing a treatment for providing hydrophobicity to the desired wall surface, and removing the protective film, so as to provide hydrophobicity to the desired wall surface, and
in the case where the substrate main body is hydrophobic,
covering a wall surface desired to be hydrophobic of the wall surface of the groove portion with a protective film, performing a treatment for providing hydrophilicity to portions excluding the desired wall surface, and removing the protective film, so as to provide hydrophobicity to the desired wall surface; and
covering the groove portion on a surface of the substrate main body with a covering member so as to form the substrate.

36. A method for producing a microchemical chip including a substrate in which a channel through which a fluid to be treated flows and a plurality of supply portions connected to the channel and from which a plurality of fluids to be treated are poured into the channel, respectively, are formed, and the channel has a bend portion on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:
forming groove portions by pressing a surface of each of at least two ceramic green sheets with a pattern having a predetermined shape and forming as appropriate a through-hole for communicating the groove portions formed in the different ceramic green sheets;
laminating another ceramic green sheet on the surface of the ceramic green sheets in which the groove portions are formed in such a manner that the groove portions are covered, and that the groove portions formed in the different ceramic green sheets are communicated through the through-hole; and
sintering the laminated ceramic green sheets at a predetermined temperature so as to form the substrate.

37. A method for producing a microchemical chip including a substrate in which a channel through which a fluid to be treated flows and a plurality of supply portions connected to the channel and from which a plurality of fluids to be treated are poured into the channel, respectively, are formed, and the channel has a bend portion on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:
forming groove portions by pressing a surface of each of at least two ceramic green sheets with a pattern having a predetermined shape and forming as appropriate a through-hole for communicating the groove portions formed in the different ceramic green sheets;
laminating another ceramic green sheet on the surface of the ceramic green sheets in which the groove portions are formed in such a manner that the groove portions are covered, and that the groove portions formed in the different ceramic green sheets are communicated through the through-hole;
sintering the laminated ceramic green sheets at a predetermined temperature to form a substrate main body; and
covering the groove portion on the substrate main body with a covering portion so as to form the substrate.

38. A method for producing a microchemical chip including a substrate in which a channel through which a fluid to be treated flows and a plurality of supply portions connected to the channel and from which a plurality of fluids to be treated are poured into the channel, respectively, are formed, and the channel has an uneven portion having an uneven wall surface on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:
forming a groove portion and forming unevenness in a predetermined wall surface of the groove portion by pressing a surface of a ceramic green sheet with a pattern having a predetermined shape;
laminating another ceramic green sheet on a surface of the ceramic green sheet in which the groove portion is formed in such a manner that the groove portion is covered; and
sintering the laminated ceramic green sheets at a predetermined temperature so as to form the substrate.

39. A method for producing a microchemical chip including a substrate in which a channel through which a fluid to be treated flows and a plurality of supply portions connected to the channel and from which a plurality of fluids to be treated are poured into the channel, respectively, are formed, and the channel has an uneven portion having an uneven wall surface on a downstream side in a flowing direction of the fluid to be treated from a position in which the supply portions are connected, wherein the plurality of fluids to be treated are poured from the plurality of supply portions into the channel, respectively, and the plurality of fluids poured are merged and subjected to a predetermined treatment, comprising:
forming a groove portion and forming unevenness on a predetermined wall surface of the groove portion by pressing a surface of a ceramic green sheet with a pattern having a predetermined shape;
sintering the ceramic green sheets in which the groove portion is formed at a predetermined temperature so as to form a substrate main body; and
covering the groove portion on the surface of the substrate main body with a covering member so as to form the substrate.
